(19) United States
(12) Patent Application Publication
(10) Pub. No.: US 2026/0174078 A1
(43) Pub. Date: Jun. 25, 2026

(54) On-Demand Pesticide Controlled Release System

(71) Applicant: Pennsylvania Molecular Research Institute, LLC, Allentown, PA (US)

(72) Inventor: Ziyad Fayez Al-Rashid, Breinigsville, PA (US)

(73) Assignee: Pennsylvania Molecular Research Institute, LLC, Allentown, PA (US)

(21) Appl. No.: 19/418,252

(22) Filed: Dec. 12, 2025

Related U.S. Application Data
(60) Provisional application No. 63/737,031, filed on Dec. 20, 2024.

(51) Int. Cl. A01N 25/10; A01N 37/38; A01P 13/00

(52) U.S. Cl. CPC A01N 25/10; A01N 37/38; A01P 13/00

(57) ABSTRACT

Pesticides, pesticide controlled release systems, and their methods for delivering an effective amount of a pesticide to an environmental medium to treat, kill, or inhibit the growth of a pest, including a weed, microbe or other undesired organism.

### CROSS-REFERENCES TO RELATED APPLICATIONS

This application claims priority to U.S. Provisional Patent Application No. 63/737,031, filed on Dec. 20, 2024, which is herein incorporated by reference in its entirety for all purposes.

### BACKGROUND

According to the United Nations, the world population is projected to grow to 9.7 billion people by 2050. More people equals an increased need for agricultural productivity, which in turn necessitates the increased use of pesticides. In 2022 alone, a total of 3.7 million tons of pesticides were used in agriculture (Pesticides use 2022—FAOSTAT Analytical Brief 89). What if we could reduce pesticide usage by 80%?What long-term impact might that have on agricultural productivity, food security, and the environment? These are the questions that fuel my research efforts. It has long been stated that “improved pesticide application technologies should help reduce pesticide use by at least half without diminishing the effectiveness of pest control. Such an accomplishment would greatly benefit public health and the environment” (D. Pimentel et al. BioScience 1986, 36, 86).

Towards improving pesticide application technologies, pesticide control release systems have been developed. The benefits of these pesticide controlled release systems include: prolonging pesticide activity by the release of low amounts of pesticide at levels sufficient for biological function over extended periods; reducing the amount of pesticide required per application; reducing the number of required applications to achieve control; reducing cost by limiting repeated and over applications; reducing environmental pollution by avoiding the conventional application of large amounts of pesticide which is accompanied by undesirable side effects from pesticide loss by evaporation, degradation and leaching into the soil or groundwater; extending the activity duration of less persistent pesticides; and gating the release of pesticides with high soil mobility (A. Akelah, Mat. Sci. Eng. C 1996, 4, 83-98; F. Puoci et al. J. Agri. & Biol. Sci. 2008, 3, 299-314; S. Dubey et al. J. Sci. Ind. Res. 2011, 70, 105-112; A. Zanino et al. European Polymer Journal 2024, 203, 112665). These technologies commit to the choice of pesticide or pesticides formulated on manufacture or during in vitro preparation of the controlled release system, including a commitment to a release rate or rates and percent pesticide or pesticides in the controlled release formulation. These technologies cannot be adjusted by the end user in the field or prior to application. An on-demand controlled release system can provide the elements of choice that are available in conventional pesticide treatments, while providing the benefits of controlled release systems. The on-demand controlled release system would give the end user the choice of what pesticide or pesticides to include in the controlled release system, when to include them, and how much to include.

I found inspiration in biomedical drug delivery technologies utilizing implantable materials that can be modified post implantation such that a drug is linked to the implanted material in the patient or test animal (U.S. Pat. Publ. 2016/0120987 and WO 2015/154082 A1). The linking involves click chemistry, several reactions of which are proposed to apply in said technologies. Translating these biomedical technologies to an agrochemical application required undue experimentation, in part due to differences in the scale of application, cost, commercial considerations, and the unique milieu of the plant growth medium and application environment (P. Lee, X. Lin, F. Khan, A. E. Bennett and J. O. Winter, Front. Biomater. Sci. 2022, 1:1011877). Cost and scale are one of the biggest differences. Healthcare applications typically require mg to g scales with a high cost tolerance, while agriculture applications require kg to ton scales with very low cost tolerance. Biocompatibility is critical to both biomedicine and agriculture, however in agriculture this encompasses a broader scope. In biomedicine, the primary concern is cell, tissue, and organ level toxicity. Agricultural technologies must consider ecotoxicology, the impact these materials would have on the soil ecosystem. To develop such an agrochemical technology further undue experimentation can include identifying linking chemistry that involves adequately shelf-stable reactive partners or developing strategies to handle relatively unstable reactive partners, screening for linking chemistry that can be performed in soil and finding satisfactory chemistry while managing cost.

### SUMMARY

I have invented a pesticide or pesticides controlled release system. The controlled release system can be assembled and/or replenished in the plant growth medium with the pesticide or pesticides of interest. In some embodiments, a biocompatible solid support is linked to a first binding agent to form a receptive biocompatible solid support. The first binding agent is selected from a pair of binding agents that link in covalent bond or bonds forming reactions, the linking chemistry, and in some embodiments the linking chemistry is click chemistry. Preferably this reaction is bioorthogonal or biocompatible linking chemistry that can be performed in or around living organisms. The receptive biocompatible solid support is placed in the plant growth medium. A second binding agent, that can link to the first binding agent, is linked to a pesticide and the link involves a cleavable linkage to the pesticide to form a conjugating agent. The conjugating agent or pesticide formulations thereof is then applied to the plant growth medium containing the receptive biocompatible solid support and the two binding agents are contacted and link, thus forming the controlled release system where pesticide is linked to the biocompatible solid support. The cleavable linkage to the pesticide cleaves under environmental conditions, and therefore the controlled release system controllably releases pesticide to the application environment. The present invention is based, in part, on the discovery that certain compounds can be linked in soil. Furthermore, the chemicals involved in the linking event are well tolerated by plants on the experimental time scale examined. Accordingly, the present invention provides methods and compositions useful for treating the growth of pests, including without any limitation weeds, using a receptive biocompatible solid support and a conjugating agent. In some embodiments, the present invention provides a method for selectively delivering a pesticide to an application environment where it is expected to encounter the pest that it is designed to control. In some embodiments this invention can be used in an agricultural field. In other embodiments this invention can be used in a lawn.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1 shows an embodiment of steps to assemble a controlled release system 48.

FIG. 2 presents the components of an embodiment of a conjugating agent 46.

FIG. 3 illustrates an embodiment of the steps of assembling a controlled release system 48 in a plant growth medium 58 and shows controlled release systems that have undergone partial 60 or complete 61 release of pesticide 50 into the application environment.

FIG. 4 shows an embodiment where sodium alginate 62 is linked to N-(2-aminoethyl)maleimide hydrochloride 64 to form a modified polymer 66, which can be crosslinking with Ca²⁺ ions to form a receptive biocompatible solid support 44.

FIG. 5 presents the preparation of a thiol linked pesticide N-(2,4-dichlorophenoxyacetyl)-L-cysteine 74.

FIG. 6 provides the 1H NMR spectrum for N,N′-bis-(2,4-dichlorophenoxyacetyl)-L-cystine 72.

FIG. 7 provides the 13C NMR spectrum for N,N′-bis-(2,4-dichlorophenoxyacetyl)-L-cystine 72.

FIG. 8 provides the 1H NMR spectrum obtained from a sample of a freshly prepared batch of N-(2,4-dichlorophenoxyacetyl)-L-cysteine 74 that was reacted with an excess of N-(2-aminoethyl)maleimide hydrochloride 64.

FIG. 9 provides the 1H NMR spectrum obtained from a batch of N-(2,4-dichlorophenoxyacetyl)-L-cysteine 74 that was first stored in a refrigerator at 8° C. for 2 weeks and then a sample was reacted with an excess of N-(2-aminoethyl)maleimide hydrochloride 64 and analyzed by NMR.

FIG. 10 provides a 400 MHz COSY spectrum (2D NMR data) of a sample of thiol-Michael adduct 76 prepared by combining 74+excess 64 (DMSO-d6 Solvent, for 1D 1H NMR Spectrum see FIG. 8).

FIG. 11 provides a selected region of a 400 MHz COSY spectrum (2D NMR data) of a sample of thiol-Michael adduct 76 prepared by combining 74+excess 64 (DMSO-d6 Solvent, for 1D 1H NMR Spectrum see FIG. 8). A substructure of thiol-Michael adduct 76 with protons labelled and the corresponding labels found on the 1D projections on the COSY spectrum are provided.

FIG. 12 shows steps involved in Ellman's Assay to determine the amount of thiol in a sample.

FIG. 13 presents Ellman's Assay results analyzing a solution of N-(2,4-dichlorophenoxyacetyl)-L-cysteine 74 over time (hours).

FIG. 14 provides a 1H NMR spectrum of a sample of Alg-N-AEMI 66 dissolved in D₂O and recorded at 50° C.

FIG. 15 presents linking via the thiol-Michael addition of N-(2,4-dichlorophenoxyacetyl)-L-cysteine 74 to Alg-N-AEMI 66 to form Alg-N-succinimidyl-thioether-2,4-D conjugate 88 (Alg-SITE-2,4-D).

FIG. 16 provides a 1H NMR spectrum of a sample of Alg-N-succinimidyl-thioether-2,4-D conjugate 88 dissolved in D₂O and recorded at 50° C.

FIG. 17 presents STEPS to determine the amount of maleimide 90 present in a sample by examining the sample thiol reactivity.

FIG. 18 provides a chart showing how a maleimide linked biocompatible solid support, Alg-N-AEMI-Ca-Crosslinked-Pellets, retains thiol reactivity after being in moist soil.

Percent %=(Sample O.D.−Base)/(Control Thiol O.D.−Base)×100

Base=O.D. reading after addition of excess Maleimide

FIG. 19 presents conditions to determine amounts of 2,4-D 68 retained by Alg-N-AEMI-Ca-Crosslinked-Pellets versus Alg-Ca-Crosslinked-Pellets when they are treated with Cys-2,4-D 74 as a phosphate-buffered saline (PBS) solution in vitro for ˜24 hours.

FIG. 20 shows a chart comparing the milligrams (mg) of 2,4-D 68 released per gram of hydrated pellet for Alg-N-AEMI-Ca-Crosslinked-Pellets versus Alg-Ca-Crosslinked-Pellets treated with Cys-2,4-D as a PBS solution in vitro for ˜24 hours.

FIG. 21 provides an HPLC trace reflecting the amount of 2,4-D 68 present in a sample. The sample is run on an HP1050 HPLC system equipped with a Variable Wavelength Detector set to 228 nm. The HPLC column used is a Kromasil 100-10PHENYL 250×4.6 mm E22530 (Temperature is 24° C.). The solvent system is isocratic and composed of H₂O (with 0.1% trifluoroacetic acid) and methanol (solvent system is H₂O w/0.1% TFA:MeOH 40:60), flowing at 2 mL per minute. Sample preparation: 20% m/v KOH in methanol (1 mL)+1 mg 2,4-D+2 mL 2M aq HCl (prior to analysis).

FIG. 22 presents a Standard Curve obtained from the HPLC Analyses of 2,4-D 68 solutions.

FIG. 23 presents conditions to compare amounts of 2,4-D 68 retained by Alg-N-AEMI-Ca-Crosslinked-Pellets versus Alg-Ca-Crosslinked-Pellets when they are treated with Cys-2,4-D 74 as a PBS solution in Soil for ˜24 hours.

FIG. 24 shows a chart comparing the 2,4-D 68 peak area found in the HPLC analyses of 2,4-D 68 released from Alg-N-AEMI-Ca-Crosslinked-Pellets versus Alg-Ca-Crosslinked-Pellets treated with Cys-2,4-D 74 as a PBS solution in Soil for ˜24 hours.

FIG. 25 presents the process of sample preparation to detect the presence of 2,4-D 68 in soil samples.

FIG. 26 shows a chart comparing the 2,4-D 68 peak area found in the HPLC analyses of 2,4-D 68 present in soil samples under three different soil conditions.

FIG. 27 presents a photograph of plants 56 growing in soil as the plant growth medium 58 that have been treated with an embodiment of the controlled release system 48.

FIG. 28 shows a photograph of seedling trays 104.

FIG. 29 presents results from a plant survival study. Group 1-0.5 mg 2,4-D/1 plant (3 lb/1 acre) (5 plants). Group 2-0.063 mg Cys-2,4-D/1 plant (0.26 lb acid equivalent/1 acre) (7 plants). Group 3—Cys-2,4-D-Conjugated-Alg-N-AEMI-Ca-Crosslinked-Pellets (5 conjugated pellets/plant) that were conjugated and washed in vitro by combining 0.063 mg Cys-2,4-D (PBS solution) per 5 Alg-N-AEMI-Ca-Crosslinked-Pellets (7 plants). Group 4-0.063 mg Cys-2,4-D/1 plant (0.26 lb acid equivalent/1 acre)+Alg-N-AEMI-Ca-Crosslinked-Pellets Conjugated in Soil (5 pellets/plant, 7 plants).

FIG. 30 presents results from another plant survival study. Group 1—No Pellets, No Pesticides (2 plants). Group 2—Alg-N-AEMI-Ca-Crosslinked-Pellets (7 pellets/plant, 6 plants). Group 3-0.096 mg Cys-2,4-D/1 plant (0.40 lb acid equivalent/1 acre) (7 plants). Group 4-0.096 mg Cys-2,4-D/1 plant (0.40 lb acid equivalent/1 acre)+Alg-N-AEMI-Ca-Crosslinked-Pellets Conjugated in Soil (7 pellets/plant, 12 plants). Group 5—0.0192 mg Cys-2,4-D/1 plant (0.08 lb acid equivalent/1 acre)+Alg-N-AEMI-Ca-Crosslinked-Pellets Conjugated in Soil (7 pellets/plant, 7 plants). Group 6-0.0096 mg Cys-2,4-D/1 plant (0.04 lb acid equivalent/1 acre)+Alg-N-AEMI-Ca-Crosslinked-Pellets Conjugated in Soil (˜7 pellets/plant, 12 plants). Group 7-0.25 mg 2,4-D/1 plant (1.5 lb/1 acre) (5 plants). Group 8-0.025 mg 2,4-D/1 plant (0.15 lb/1 acre) (14 plants). Group 9-0.05 mg 2,4-D/1 plant (0.30 lb/1 acre) (7 plants).

### DRAWINGS—REFERENCE NUMERALS

40—Biocompatible solid support
42—First binding agent
44—Receptive biocompatible solid support
46—Conjugating agent
48—Controlled release system
50—Pesticide
52—Linker
54—Second binding agent
56—Plant
58—Plant growth medium
59—Application environment
60—Controlled release system that has undergone partial release of pesticide
61—Controlled release system that has undergone complete release of pesticide
62—Sodium alginate (m is a whole number greater than or equal to 2, and preferably greater than or equal to about 150 or less than or equal to about 2050)
64—N-(2-Aminoethyl)maleimide hydrochloride
66—Alg-N-AEMI—sodium alginate that is linked to maleimide by covalent bonds (x and y are whole numbers greater than or equal to 0, and preferably greater than or equal to about 150 or less than or equal to about 2050)
68—Pesticide 2,4-D (2,4-dichlorophenoxyacetic acid)
70—L-Cystine
72—N,N′-Bis-(2,4-dichlorophenoxyacetyl)-L-cystine
74—N-(2,4-Dichlorophenoxyacetyl)-L-cysteine (Cys-2,4-D)
76—N-(2,4-Dichlorophenoxyacetyl)-L-cysteine N-(2-aminoethyl)maleimide hydrochloride thiol-Michael Adduct
78—Substructure of thiol-Michael adduct 76 with proton labels
80—5,5′-Dithiobis-(2-nitrobenzoic acid) (DTNB), Ellman's reagent
82—Disulfide formed in the Ellman's Assay of Cys-2,4-D
84—5-Mercapto-2-nitrobenzoic acid
86—TNB²⁻ (dianion of 5-thio-2-nitrobenzoic acid)
88—Alg-N-succinimidyl-thioether-2,4-D conjugate (Alg-SITE-2,4-D)
90—A maleimide
92—4-Nitrobenzenethiol
94—Maleimide 4-nitrobenezenethiol thiol-Michael adduct
96—Grow lights and vent
98—Humidity dome
100—Base tray
102—Seedling heat mat
104—Seedling tray

### DETAILED DESCRIPTION

### Advantages

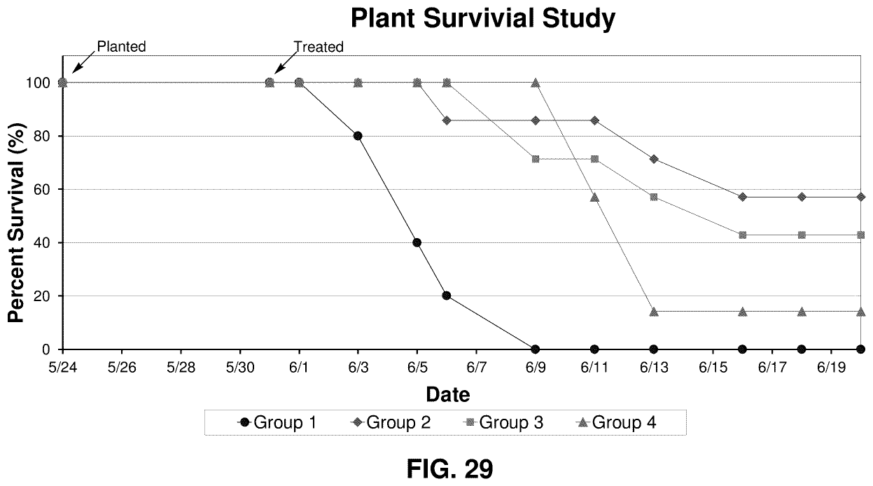

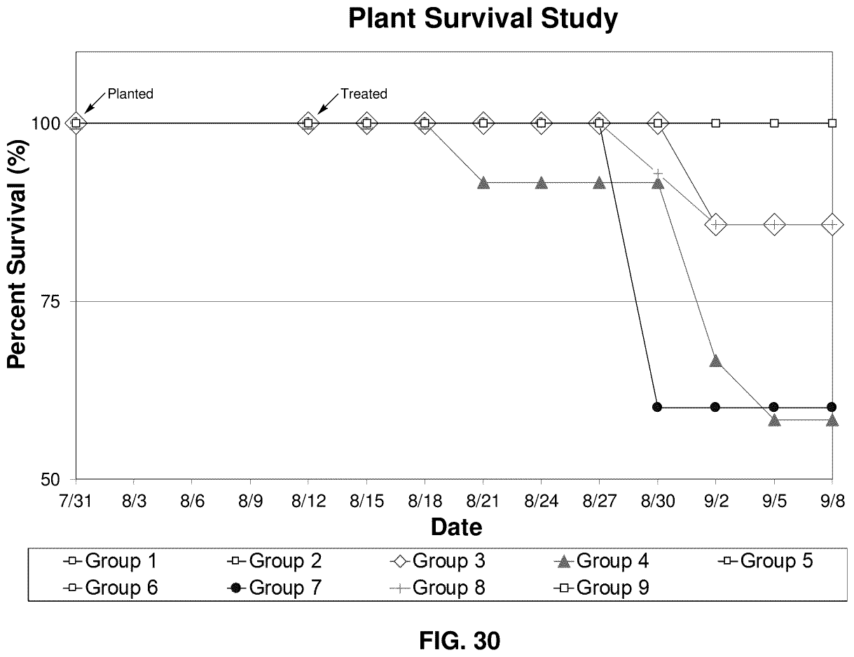

Although others have invented pesticide controlled release systems, various aspects of my controlled release system are superior because:
It can be formed and replenished in the plant growth medium. This provides the user with control over when the controlled release system is formed and thus initiate or at least set the stage for pesticide controlled release, the invention provides the user with a choice of what pesticide or pesticides are introduced into the controlled release system, and the invention gives the user options regarding how much pesticide to link to the receptive biocompatible solid support and therefore how much pesticide will be released. This on-demand pesticide controlled release system serves as a pesticide depot that can be charged or replenished as needed.
It provides the benefits of controlled release systems including: prolonging pesticide activity by the release of low amounts of pesticide at levels sufficient for biological function over extended periods; reducing the amount of pesticide required per application; reducing the number of required applications to achieve control; reducing cost by limiting repeated and over applications; reducing environmental pollution by avoiding the conventional application of a large amounts of pesticide which is accompanied by undesirable side effects from pesticide loss by evaporation, degradation and leaching into the soil or groundwater; extending the activity duration of less persistent pesticides; and gating the release of pesticides with high soil mobility. Other strategies suffer from the commitment to a specific pesticide or pesticides during their manufacture and cannot utilize another pesticide or other pesticides on-demand.
It involves cleavable linkages that are cleaved to release pesticide. Those skilled in the art will see that these linkages can be modified to adjust the rate of pesticide release from the controlled release system (for example by requiring the hydrolysis of an amide bond versus an ester bond for pesticide release—see “Engineering Biomaterial-Drug Conjugates for Local and Sustained Chemotherapeutic Delivery” J. M. Coburn and D. L. Kaplan, Bioconjug Chem. 2015, 26, 1212-1223).
Conjugating agents and pesticide formulations thereof can have diminished pesticidal activity. This can be seen, in for example, the higher survival rates of plants treated with just N-(2,4-dichlorophenoxyacetyl)-L-cysteine (Cys-2,4-D), an embodiment of a conjugating agent, in our plant survival studies compared to groups treated with embodiments of this on-demand control release system or with unmodified pesticide (see FIG. 29 and FIG. 30). This reduces the hazards of working with the conjugating agents and pesticide formulations thereof and would for example reduce the negative impact of pesticide drift during applications. Furthermore, conjugating agents can be less volatile than the respective unmodified pesticide and can therefore be less susceptible to vapor drift than the respective unmodified pesticide. Pesticidal activity of modified pesticides in the form of conjugating agents can be restored when the pesticide is released from the controlled release system.
Receptive biocompatible solid supports can be prepared such that they encapsulate components to be released into the application environment, including pesticides, microbes, enzymes, fertilizers, nutrients and other agrochemicals. Furthermore, the receptive biocompatible solid supports can be superabsorbent polymers (SAPs) used for agricultural water retention. Due to high water absorption and water retention capacity, SAPs can be applied to effectively improve utilization of water in agriculture, such as retaining moisture in the soil and reducing irrigation water consumption.
Reagents for the preparation of both the receptive biocompatible solid supports and the conjugating agents are commercially available, with several related applications demonstrated in polymer modification and monoclonal antibody modification, including the installation of prodrugs, enzymes, small molecular drugs, radiotracers, and fluorescent probes.

### DESCRIPTION AND OPERATION

### I. General

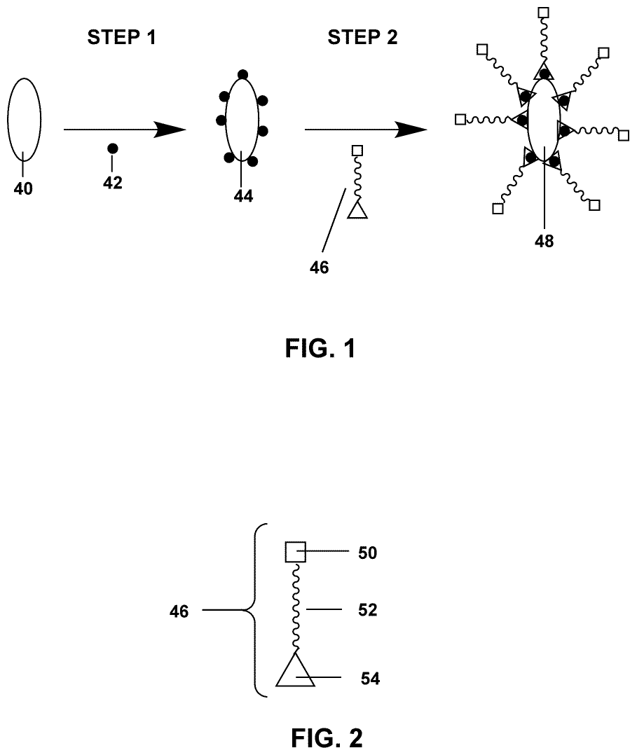

FIG. 1—shows embodiments in which receptive biocompatible solid supports 44 are prepared by linking biocompatible solid supports 40 with a first binding agent 42, followed by being contacted with a conjugating agent 46 to deliver the controlled release system 48.

FIG. 2—shows embodiments of the conjugating agent 46 comprised of second binding agent 54, a linker 52, and a pesticide 50.

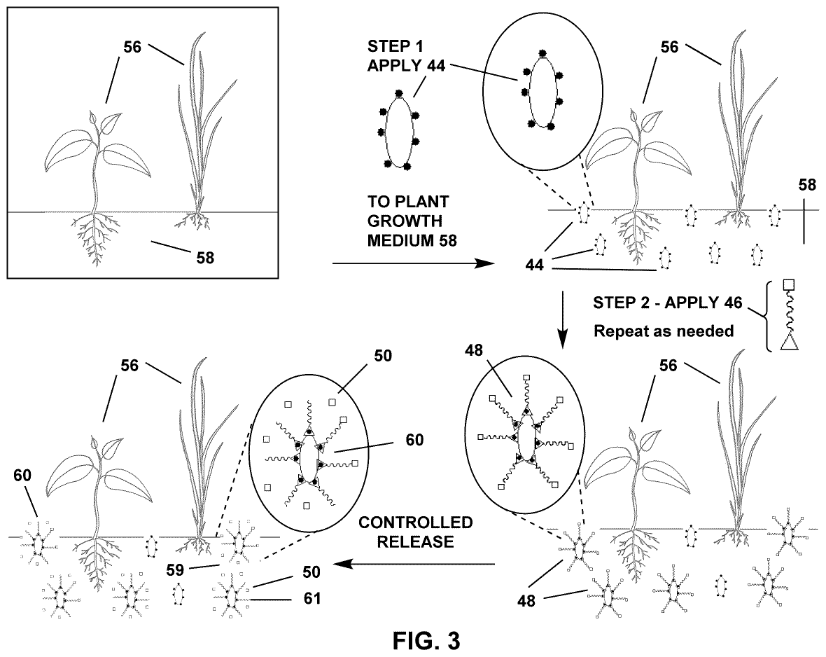

FIG. 3—shows embodiments of the controlled release system 48 where receptive biocompatible solid supports 44 are applied to a plant growth medium 58 containing plants 56. In some embodiments, conjugating agent 46 is then applied thus contacting the binding agents to form controlled release systems 48 in the plant growth medium 58. In some embodiments, controlled release system 48 formation when the two binding agents are contacted and link, may not consume all the receptive biocompatible solid supports 44 or link to all the binding agents in the plant growth medium 58 or all the binding agents on each receptive biocompatible solid support 44. This allows for repeated application of conjugating agents 46 that would produce controlled release systems 48. Controlled release systems 48 then undergo partial (48 converts to 60) or complete release (48 converts to 61) of the pesticide 50 into the application environment 59.

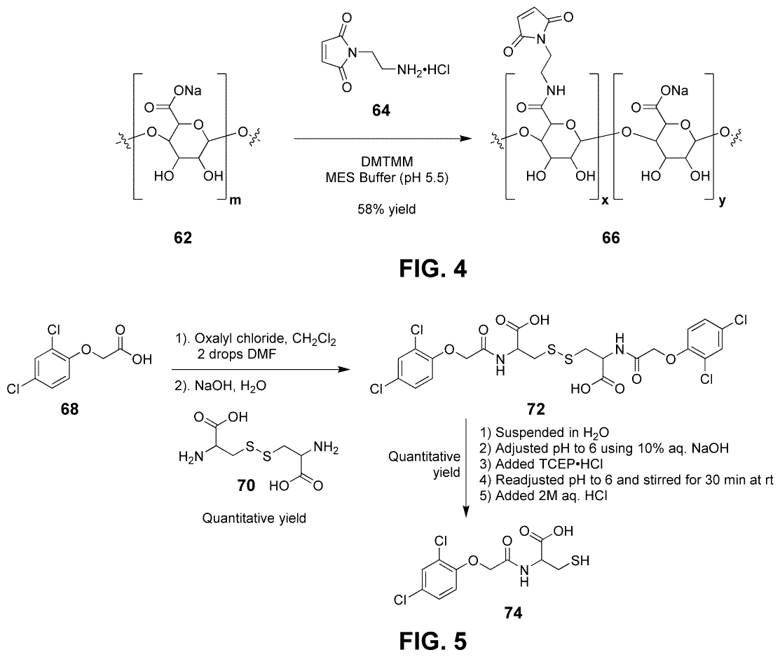

FIG. 4—shows an embodiment where sodium alginate 62 is contacted with N-(2-aminoethyl)maleimide hydrochloride 64 to form alginate that is linked to a maleimide by covalent bonds (Alg-N-AEMI 66). Alg-N-AEMI 66 can be crosslinked in the presence of Ca²⁺ ions (for example when exposed to a solution of calcium chloride, see EXPERIMENTAL section—EXAMPLE 6—Preparation of Alg-N-AEMI-Ca-Crosslinked-Pellets) to form a hydrogel shaped as pellets (for a sample procedure see B. Tomadoni, M. F. Salcedo, A. Y. Mansilla, C. A. Casalongué, V. A. Alvarez, European Polymer Journal 2020, 137, 109953). Alg-N-AEMI-Ca-Crosslinked-Pellets are an embodiment of receptive biocompatible solid supports 44. The molecular weight of commercially available sodium alginates range between 32,000 and 400,000 g/mol (K. Y. Lee and D. J. Mooney, Prog. Polym. Sci. 2012, 37, 106-126).

FIG. 5—presents the preparation of a thiol linked pesticide, an embodiment of a conjugating agent 46. The pesticide 2,4-D 68 (2,4-dichlorophenoxyacetic acid) is coupled to L-cystine 70 to form N,N′-bis-(2,4-dichlorophenoxyacetyl)-L-cystine 72. N,N′-Bis-(2,4-dichlorophenoxyacetyl)-L-cystine 72 is reduced by tris(2-carboxyethyl)phosphine (TCEP) to obtain N-(2,4-dichlorophenoxyacetyl)-L-cysteine 74 (Cys-2,4-D).

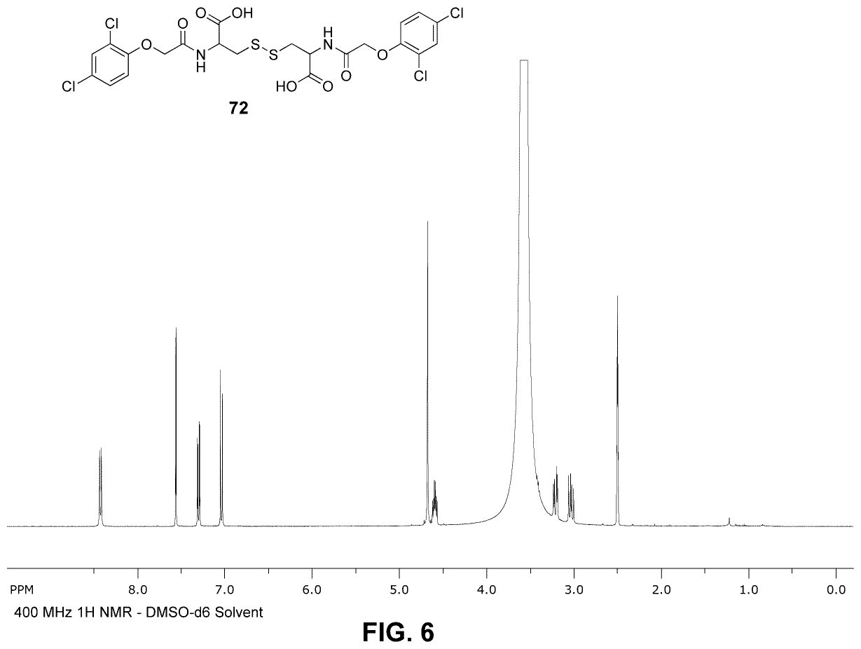

FIG. 6—shows the 1H NMR spectrum for N,N′-bis-(2,4-dichlorophenoxyacetyl)-L-cystine 72 (see below).

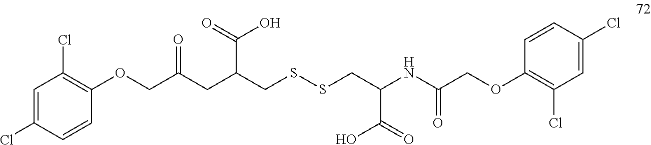 [SMILES: O=C(COc1ccc(Cl)cc1Cl)CC(CSSCC(NC(=O)COc1ccc(Cl)cc1Cl)C(=O)O)C(=O)O]

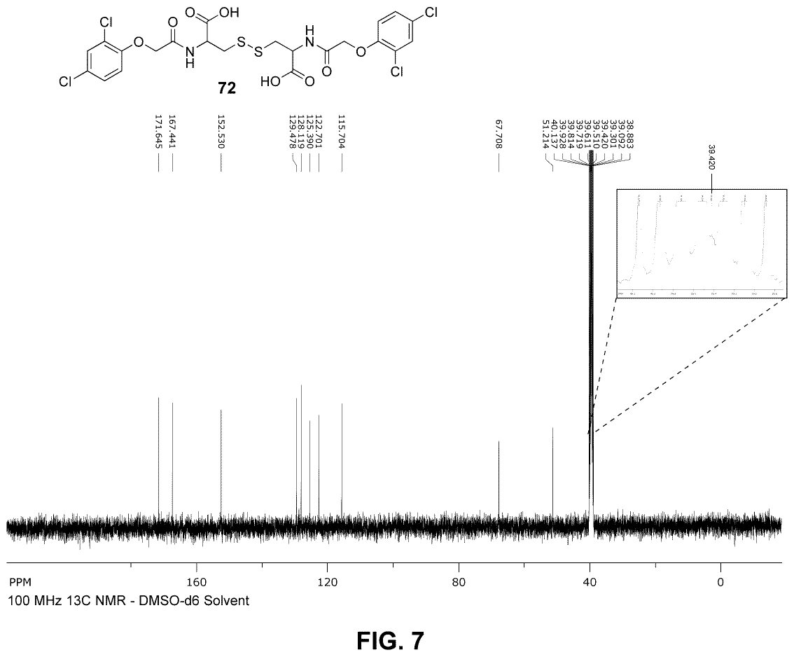

FIG. 7—provides the 13C NMR spectrum for N,N′-bis-(2,4-dichlorophenoxyacetyl)-L-cystine 72 (see above).

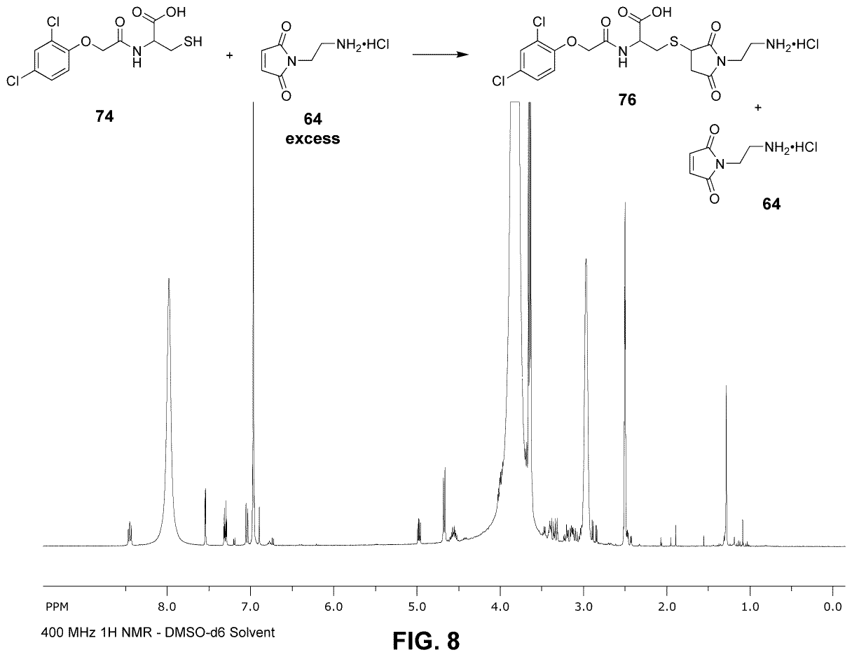

FIG. 8—provides the 1H NMR spectrum obtained from a sample of a freshly prepared batch of N-(2,4-dichlorophenoxyacetyl)-L-cysteine 74 (Cys-2,4-D) that was reacted with an excess of N-(2-aminoethyl)maleimide hydrochloride 64 to form the thiol-Michael adduct 76 (see below). Integration of 1H-NMR proton signals in the aromatic region revealed that >95% of the 2,4-D derivatives in the sample were the thio-Michael adduct 76, and therefore prepared N-(2,4-dichlorophenoxyacetyl)-L-cysteine 74 must be >95% of the 2,4-D-derivatives in the prepared batch (see FIG. 8).

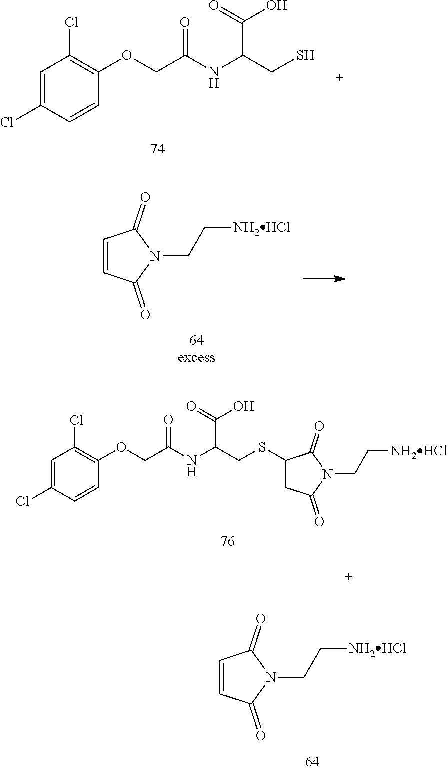

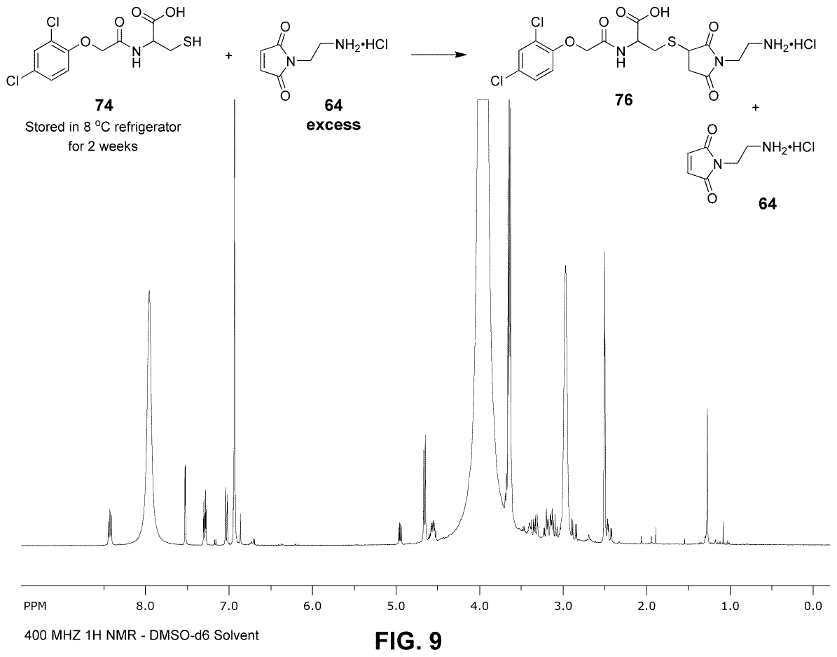

FIG. 9—provides the 1H NMR spectrum obtained from a batch of N-(2,4-dichlorophenoxyacetyl)-L-cysteine 74 (Cys-2,4-D) that was first stored in an refrigerator at 8° C. for 2 weeks and then a sample was reacted with an excess of N-(2-aminoethyl)maleimide hydrochloride 64 to form the thiol-Michael adduct 76 and analyzed by NMR (see below). Integration of 1H-NMR proton signals in the aromatic region revealed that >95% of the 2,4-D derivatives in the sample were the thio-Michael adduct, and therefore N-(2,4-dichlorophenoxyacetyl)-L-cysteine 74 must be >95% of the 2,4-D-derivatives in the prepared and stored batch, comparable to what was found in the same batch of Cys-2,4-D 74 when it was freshly prepared (see FIG. 8).

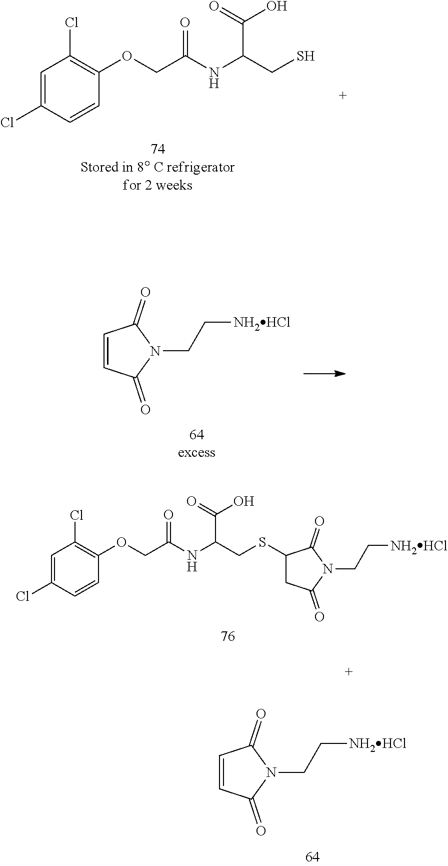

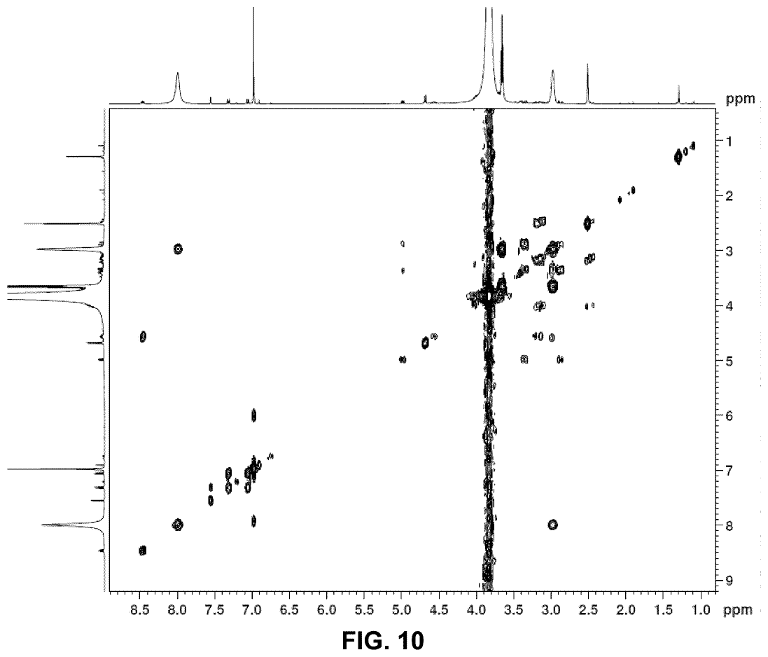

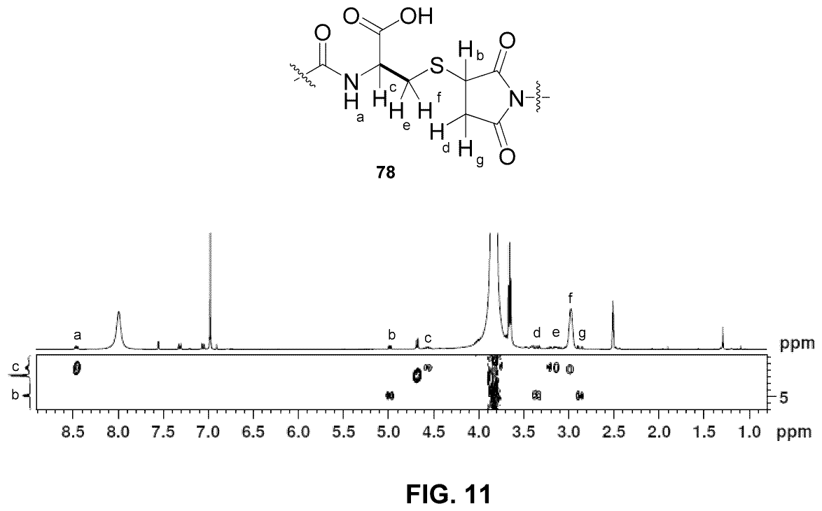

FIG. 10 provides a COSY spectrum (2D NMR data) obtained from a sample of a freshly prepared batch of N-(2,4-dichlorophenoxyacetyl)-L-cysteine 74 (Cys-2,4-D) that was reacted with an excess of N-(2-aminoethyl)maleimide hydrochloride 64 to form the thiol-Michael adduct 76. The 1D 1H NMR spectrum for this sample can be found in FIG. 8. FIG. 11 provides a selected region of the FIG. 10 COSY spectrum. Included in FIG. 11 is a substructure 78 (see below) of thiol-Michael adduct 76 with protons labelled and the corresponding labels found on the 1D projections on the COSY spectrum. The 1D 1H NMR spectrum for this sample can be found in FIG. 8.

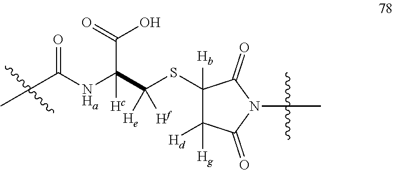

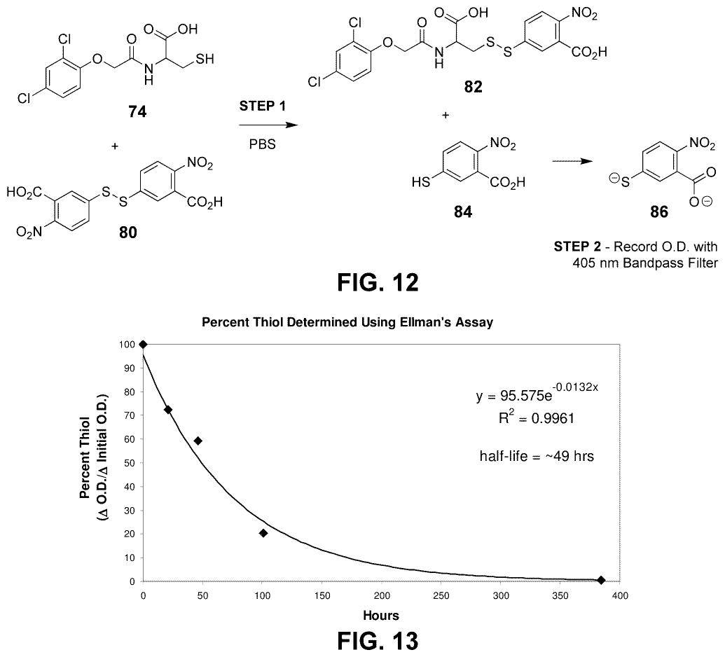

FIG. 12 shows the steps involved in Ellman's Assay to determine the amount of free thiol in a sample. In STEP 1, a sample of the thiol, N-(2,4-dichlorophenoxyacetyl)-L-cysteine 74 (Cys-2,4-D), is treated with 5,5′-dithiobis-(2-nitrobenzoic acid) 80 (DTNB). In STEP 2, the optical density (O.D.) of the resulting mixture is measured on an absorbance microplate reader using a 405 nm Bandpass Filter to detect TNB²⁻ 86 in solution.

FIG. 13 presents Ellman's Assay results on a solution of N-(2,4-dichlorophenoxyacetyl)-L-cysteine 74 (Cys-2,4-D) over time (hours). The decay is fitted to an exponential function with the trend line and equation shown. The half-life of N-(2,4-dichlorophenoxyacetyl)-L-cysteine 74 (Cys-2,4-D) in the PBS solution (pH adjusted to ˜8) is found to be 49 hours.

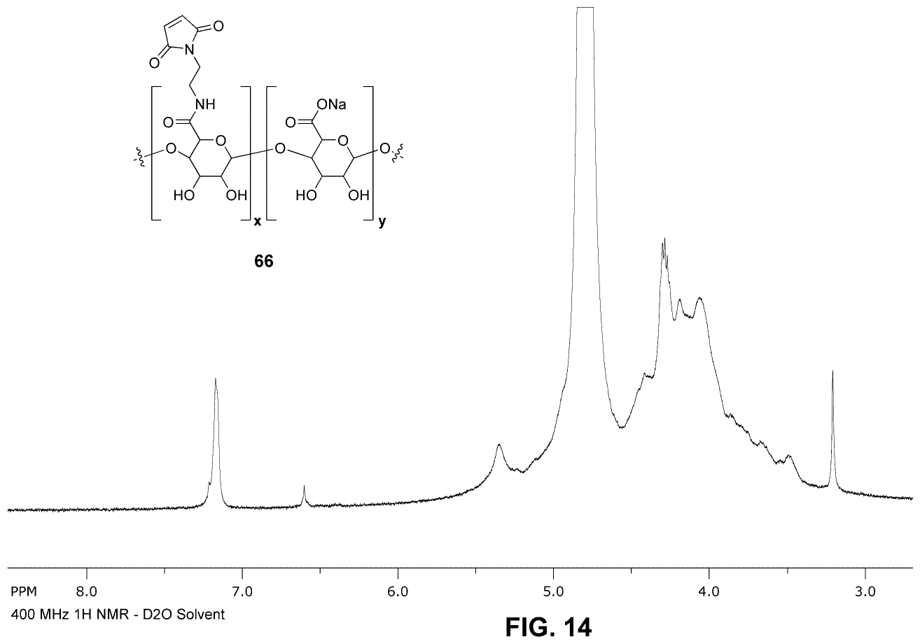

FIG. 14 provides a 1H NMR spectrum of a sample of Alg-N-AEMI 66 (see below) dissolved in D₂O and recorded at 50° C. 1H-NMR Integration: 2 (vinyl maleimide protons at ˜7.2 ppm) to 37.2 (maleimide linker (4 protons) and saccharide alcohol methines (3 per saccharide) 3.4 to 4.6 ppm). When adjusted by subtracting the estimated integration value for linker protons: 2 (vinyl maleimide 6.9 ppm) to 33.2 (saccharide alcohol methines (3 per saccharide) 3.4 to 4.6 ppm). Ratio Maleimide:Saccharide=1:11.06 (Maleimide is 6.73 wt %), Degree of Modification (DM)=9.04%.

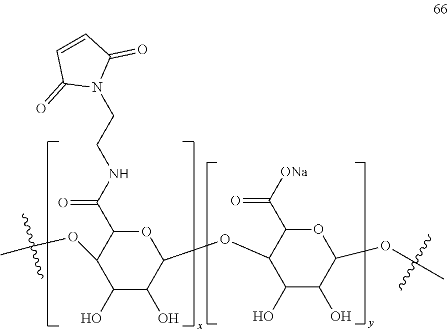

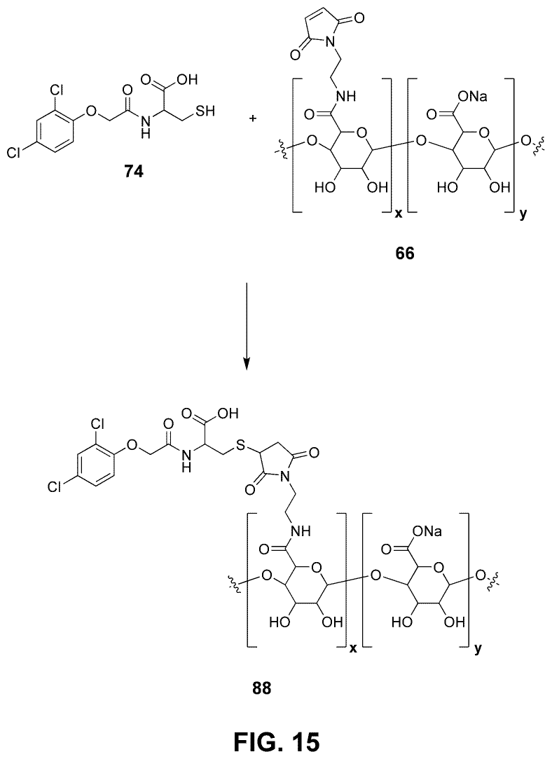

FIG. 15 presents linking via the thiol-Michael addition of Cys-2,4-D 74 to Alg-N-AEMI 66 to form Alg-N-succinimidyl-thioether-2,4-D conjugate 88 (Alg-SITE-2,4-D).

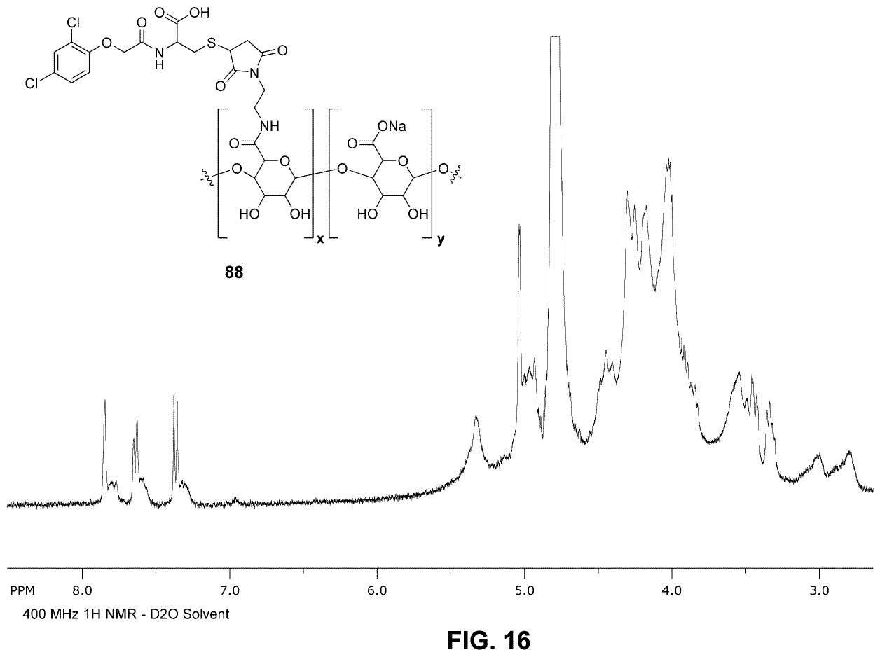

FIG. 16 provides a 1H NMR spectrum of a sample of Alg-N-succinimidyl-thioether-2,4-D conjugate 88 (see below) dissolved in D₂O and recorded at 50° C. 88 is a thiol-Michael addition product formed in the reaction of the maleimide Alg-N-AEMI 66 with the thiol Cys-2,4-D 74. The vinyl maleimide protons of Alg-N-AEMI 66 seen at ˜7.2 ppm in the 1H NMR spectrum of Alg-N-AEMI 66 (FIG. 14) are not observed in the FIG. 16 1H NMR spectrum indicating complete consumption of maleimide during Cys-2,4-D 74 conjugation. Furthermore, the appearance of characteristic aromatic 2,4-D proton signals in the aromatic region (7-8 ppm) in the 1H NMR spectrum reflects the success of the conjugation.

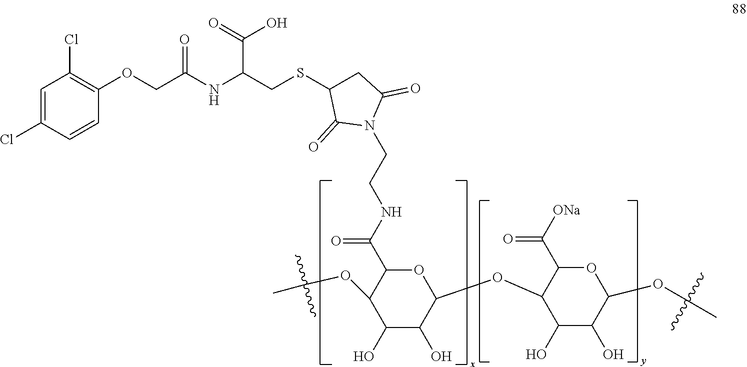

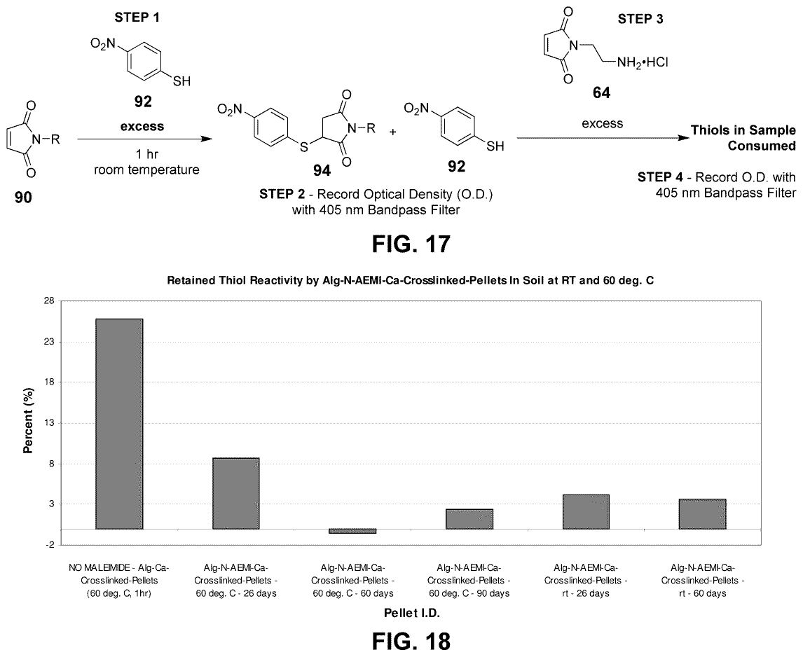

FIG. 17 presents a reaction between a maleimide 90 and 4-nitrobenzenethiol 92 to form a thiol-Michael adduct 94 (STEP 1). The amount of unreacted 4-nitrobenzenethiol 92 can be monitored using an absorbance microplate reader to measure the O.D. of the sample using a 405 nm Bandpass Filter (STEP 2). A decrease in the sample O.D. after STEP 1, reflects the presence of a thiol reactive moiety such as maleimide 90. In STEP 3 an excess of N-(2-aminoethyl)maleimide hydrochloride 64 is added to the sample after the initial O.D. reading. Any residual thiol 92 is thus consumed, and an O.D. reading is recorded to determine the base O.D. of the sample.

FIG. 18 provides a chart showing how a maleimide linked biocompatible solid support (an example of a receptive biocompatible solid support 44), Alg-N-AEMI-Ca-Crosslinked-Pellets, retains thiol reactivity (using the assay presented in FIG. 17) after being stored in wet soil for 26, 60, and 90 days at 60° C. and for 26 and 60 days at room temperature. An unmodified biocompatible solid support, Alg-N—Ca-Crosslinked-Pellets (pellets obtained when sodium alginate 62 is crosslinked in the presence of calcium chloride), analyzed using the same assay (FIG. 17) had a higher O.D. reading indicating that the assay can distinguish the presence or lack of maleimide 90 in a sample (FIG. 17). Percent %=(((Sample O.D. at 1 hr)−Sample Base)/((Control Thiol O.D. reading)−Control Base))×100 (Base=O.D. reading after addition of excess of N-(2-aminoethyl)maleimide hydrochloride 64).

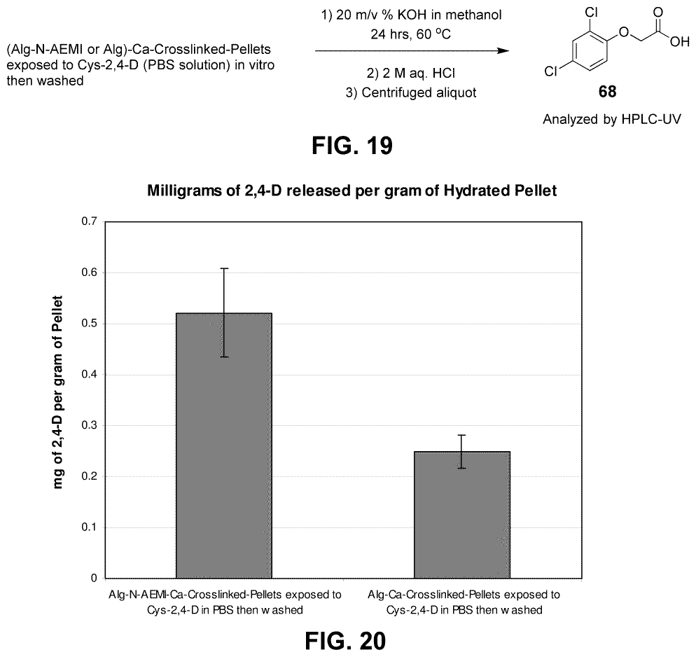

FIG. 19 presents conditions to compare amounts of 2,4-D retained by Alg-N-AEMI-Ca-Crosslinked-Pellets versus Alg-Ca-Crosslinked-Pellets when they are treated with Cys-2,4-D 74 (see below) as a PBS solution in vitro for ˜24 hours. After exposure for the appropriate time, the pellets are washed with 0.1% aq. NaOH and then water, isolated, and then treated with 20% m/v potassium hydroxide in methanol for 24 hours at 60° C. The amide bond in Cys-2,4-D 74 and/or linked 2,4-D is hydrolyzed and thus 2,4-D 68 is released under these conditions. The resulting mixture is acidified with 2 M aq. HCl, an aliquot is centrifuge, and then the aliquot is analyzed by HPLC-UV to determine the amount of released 2,4-D 68 present in the sample. The sample is run on an HP1050 HPLC system equipped with a Variable Wavelength Detector set to 228 nm. The HPLC column used is a Kromasil 100-10PHENYL 250×4.6 mm E22530 (Temperature is 24° C.). The solvent system is isocratic and composed of H₂O (with 0.1% trifluoroacetic acid) and methanol (solvent system is H₂O w/0.1% TFA:MeOH 40:60), flowing at 2 mL per minute. 10 μL of the sample is injected using the HP1050 Autosampler.

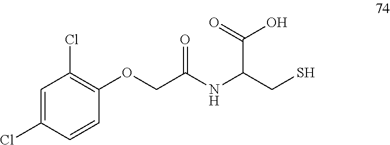 [SMILES: O=C(COc1ccc(Cl)cc1Cl)NC(CS)C(=O)O]

FIG. 20 shows a chart comparing the milligrams (mg) of 2,4-D 68 released per gram of hydrated pellet for Alg-N-AEMI-Ca-Crosslinked-Pellets versus Alg-Ca-Crosslinked-Pellets treated with Cys-2,4-D 74 in vitro (assay presented in FIG. 19). Alg-N-AEMI-Ca-Crosslinked-Pellets (three samples analyzed) are found to release more 2,4-D 68 than Alg-Ca-Crosslinked-Pellets (two samples analyzed).

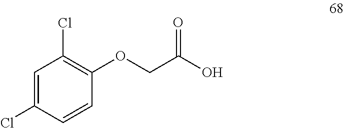 [SMILES: O=C(O)COc1ccc(Cl)cc1Cl]

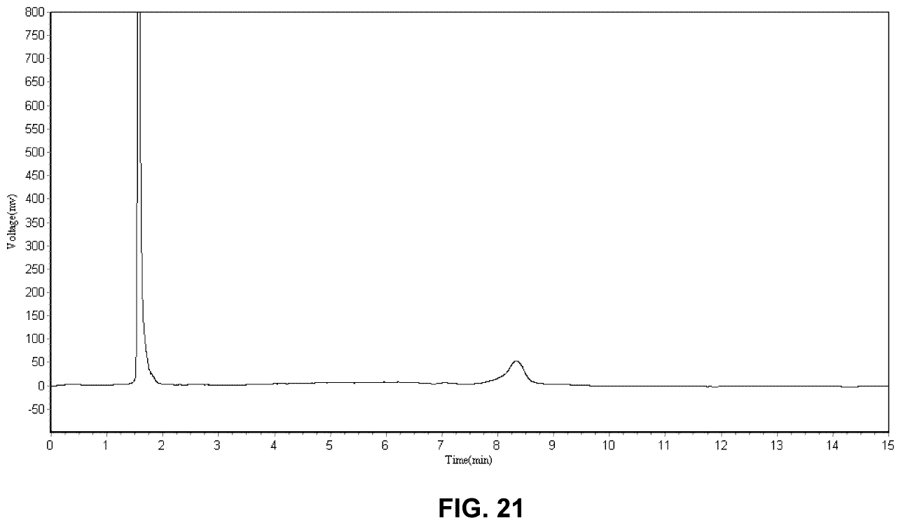

FIG. 21 provides an HPLC trace reflecting the amount of 2,4-D 68 present in a sample. The 2,4-D peak is centered at ˜8.3 minutes. The sample is run on an HP1050 HPLC system equipped with a Variable Wavelength Detector set to 228 nm. The HPLC column used is a Kromasil 100-10PHENYL 250×4.6 mm E22530 (Temperature is 24° C.). The solvent system is isocratic and composed of H₂O (with 0.1% trifluoroacetic acid) and methanol (solvent system is H₂O w/0.1% TFA:MeOH 40:60), flowing at 2 mL per minute. The sample is prepared by exposing 2,4-D 68 to 20% m/v KOH in methanol followed by acidification with 2 M aq. HCl. 10 μL of the resulting sample mixture is injected using the HP1050 Autosampler.

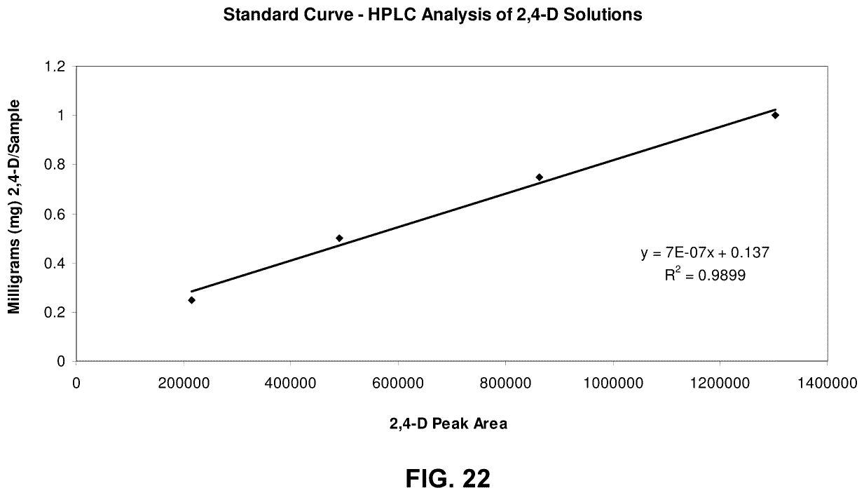

FIG. 22 presents a Standard Curve obtained from the HPLC Analyses of 2,4-D solutions. The HPLC conditions presented in FIG. 21 were applied to samples with varied amounts of 2,4-D 68. The Standard Curve establishes a relationship between the 2,4-D peak area in the HPLC trace and milligrams (mg) of 2,4-D 68 in the sample.

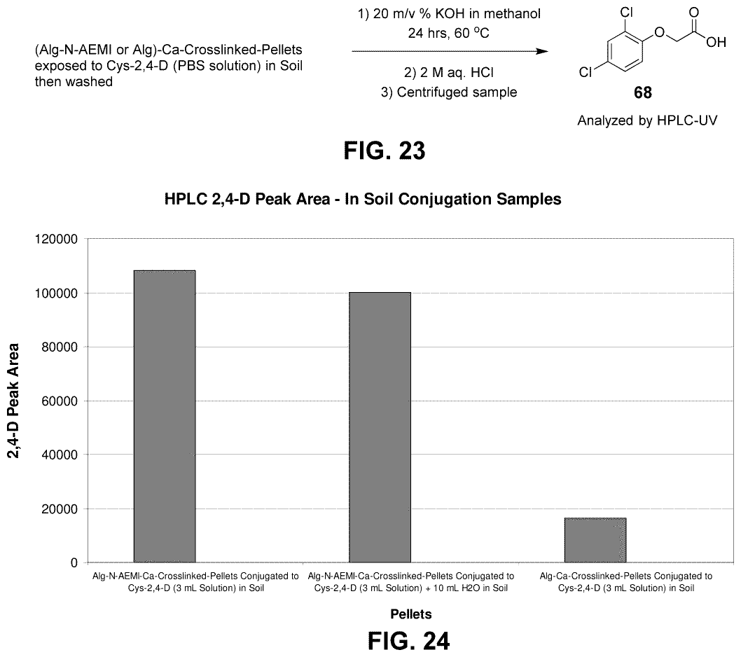

FIG. 23 presents conditions to compare amounts of 2,4-D retained by Alg-N-AEMI-Ca-Crosslinked-Pellets versus Alg-Ca-Crosslinked-Pellets when they are treated with Cys-2,4-D 74 as a PBS solution in Soil for ˜24 hours. After exposure for the appropriate time, the pellets are washed with 0.05% aq. NaOH and then water, isolated, and then treated with 20% m/v potassium hydroxide in methanol for 24 hours at 60° C. The amide bond in Cys-2,4-D 74 and/or linked 2,4-D is hydrolyzed and thus 2,4-D 68 is released under these conditions. The resulting sample mixture is acidified with 2 M aq. HCl, centrifuged and then analyzed by HPLC-UV to determine the amount of 2,4-D 68 present in the sample. The sample is run on an HP1050 HPLC system equipped with a Variable Wavelength Detector set to 228 nm. The HPLC column used is a Kromasil 100-10PHENYL 250×4.6 mm E22530 (Temperature is 24° C.). The solvent system is isocratic and composed of H₂O (with 0.1% trifluoroacetic acid) and methanol (solvent system is H₂O w/0.1% TFA:MeOH 40:60), flowing at 2 mL per minute. 10 μL of the sample is injected using the HP1050 Autosampler.

FIG. 24 shows a chart comparing the 2,4-D peak area found in the HPLC analyses of 2,4-D 68 released from Alg-N-AEMI-Ca-Crosslinked-Pellets versus Alg-Ca-Crosslinked-Pellets treated with Cys-2,4-D 74 as a PBS solution in Soil for ˜24 hours (assay presented in FIG. 23). There are two conditions tested with Alg-N-AEMI-Ca-Crosslinked-Pellets, one only exposing the pellets to 3 mL of the Cys-2,4-D PBS solution, the other adding 10 mL of water in addition to the 3 mL of the Cys-2,4-D PBS solution to further wet the soil. Both conditions led to the detection of comparable amounts of 2,4-D 68 released from the pellets according to the 2,4-D peak area in the HPLC analyses. Analysis of Alg-Ca-Crosslinked-Pellets treated with 3 mL of the Cys-2,4-D PBS solution detected less 2,4-D 68 compared to either Alg-N-AEMI-Ca-Crosslinked-Pellets tested conditions according the 2,4-D peak area in the HPLC analyses.

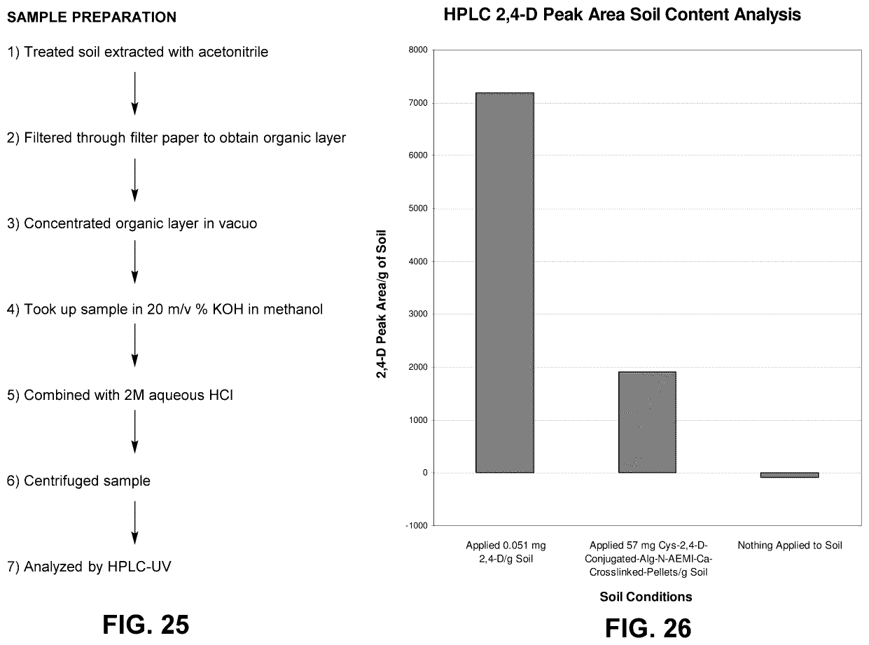

FIG. 25 presents the process of sample preparation to detect the presence of 2,4-D 68 in soil samples. The soil sample is extracted with acetonitrile, and then filtered through filter paper to obtain an organic layer. The organic layer is concentrated in vacuo, and the residue taken up in 20% m/v KOH in methanol and then acidified with 2 M aq. HCl. An aliquot of the sample is then centrifuged and then analyzed by HPLC-UV. The analysis is run on an HP1050 HPLC system equipped with a Variable Wavelength Detector set to 228 nm. The HPLC column used is a Kromasil 100-10PHENYL 250×4.6 mm E22530 (Temperature is 24° C.). The solvent system is isocratic and composed of H₂O (with 0.1% trifluoroacetic acid) and methanol (solvent system is H₂O w/0.1% TFA:MeOH 40:60), flowing at 2 mL per minute. 10 μL of the centrifuged aliquot is injected using the HP1050 Autosampler.

FIG. 26 shows a chart comparing the 2,4-D peak area found in the HPLC analyses of 2,4-D 68 present in soil samples under three different soil conditions. One soil sample was treated with 0.051 mg of 2,4-D 68 per gram of soil (˜40 grams of soil). Cys-2,4-D-Conjugated-Alg-N-AEMI-Ca-Crosslinked-Pellets were applied to another soil sample at rate of 57 mg per gram of soil (˜56 grams of soil). For both soil samples, the soil was placed in separate seedling trays 104 under grow lights and vent 96 with the lights on for 15 hours a day under a humidity dome 98, and was misted with 1.5 mL of water per day for a total of 7 days. The last condition tested was untreated soil where nothing was applied to the soil (˜36 grams of soil). The soil samples were processed according to the sample preparation presented in FIG. 25. 2,4-D 68 was detected in the 2,4-D treated soil sample and the Cys-2,4-D-Conjugated-Alg-N-AEMI-Ca-Crosslinked-Pellets treated soil sample as seen in the respective 2,4-D peak areas per gram of soil. A 2,4-D peak in the HPLC trace for the untreated soil sample was not observed in the HPLC analysis (for an example see FIG. 21). Integration of the respective region in the HPLC trace associated with the 2,4-D peak yielded a negative peak area.

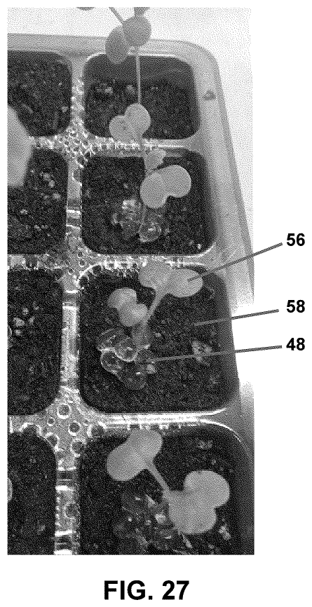

FIG. 27 presents a photograph of plants 56, these are Sinapis arvensis (wild mustard), growing in soil as the plant growth medium 58. The controlled release system 48 was assembled on the soil by applying a receptive biocompatible solid support 44 in the form of Alg-N-AEMI-Ca-Crosslinked-Pellets. Conjugating agent 46 in the form of Cys-2,4-D formulated as a PBS solution was applied by pipette to the receptive biocompatible solid support 44, Alg-N-AEMI-Ca-Crosslinked-Pellets, to generate the controlled release system 48.

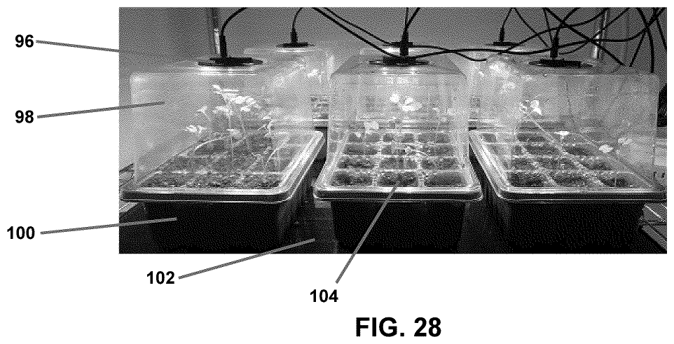

FIG. 28 shows a photograph of seedling trays 104 with humidity domes 98 and grow lights with vents 96, placed on a seedling heat mat 102. Seedling trays 104 are subdivided into twelve cells, and are contained in base trays 100.

FIG. 29 presents results from a plant survival study where Sinapis arvensis (wild mustard) plants were grown in seedling trays 104 with humidity domes 98 and grow lights with vents 96 (see FIG. 28). Grow lights were operated on a timer for 15 consecutive hours a day starting at 5:30 a.m. The date the seeds were planted is noted (5/24). Seedling were then treated 7 days after planting as noted (5/31) with the following conditions. Four groups were studied, where seedling trays were dedicated to only one of these groups per tray. Group 1 (5 plants) was treated with 0.5 mg 2,4-D per plant (100 μL of solution with 5 mg 2,4-D per mL PBS and 16.67 μL of 10% aq. NaOH per mL of PBS, equivalent to 3 lb 2,4-D per acre). Group 2 (7 plants) was treated with 0.063 mg N-(2,4-dichlorophenoxyacetyl)-L-cysteine (Cys-2,4-D 74) per plant (100 μL of solution with 0.63 mg Cys-2,4-D per mL PBS and 16.67 μL of 10% aq. NaOH per mL of PBS, 0.26 lb acid equivalent per acre). Group 3 (7 plants) was treated with Cys-2,4-D-Conjugated-Alg-N-AEMI-Ca-Crosslinked-Pellets that were linked in vitro by combining 0.063 mg Cys-2,4-D (100 μL of solution with 0.63 mg Cys-2,4-D per mL PBS and 16.67 μL of 10% aq. NaOH per mL of PBS) per 5 pellets of Alg-N-AEMI-Ca-Crosslinked-Pellets for 30 minutes at room temperature and then washing with 6×20 mL of water. Cys-2,4-D-Conjugated-Alg-N-AEMI-Ca-Crosslinked-Pellets were applied at a rate of 5 pellets per plant. Group 4 (7 plants) was treated with Cys-2,4-D-Conjugated-Alg-N-AEMI-Ca-Crosslinked-Pellets that were linked in the soil. In soil linking was achieved as follows: Alg-N-AEMI-Ca-Crosslinked-Pellets were applied at a rate of 5 pellets per plant. 0.063 mg N-(2,4-dichlorophenoxyacetyl)-L-cysteine (Cys-2,4-D 74) per plant (100 μL of solution with 0.63 mg Cys-2,4-D per mL PBS and 16.67 μL of 10% aq. NaOH per mL of PBS, 0.26 lb acid equivalent per acre) was then applied to the pellets and plants. All plants were watered on the dates where plant survival was assessed (every 2 to 3 days) with 0.5 mL of water per plant. The 2,4-D treated plants in Group 1 decreased to zero surviving plants 9 days after treatment. The Cys-2,4-D-Conjugated-Alg-N-AEMI-Ca-Crosslinked-Pellets linked in the soil treated plants in Group 4 decreased to one surviving plant 13 days after treatment. Both Cys-2,4-D treated (Group 2) and Cys-2,4-D-Conjugated-Alg-N-AEMI-Ca-Crosslinked-Pellets conjugated in vitro treated plants (Groups 3) had higher % surviving plants at the end of the study.

FIG. 30 presents results from a plant survival study where Sinapis arvensis (wild mustard) plants were grown in seedling trays 104 with humidity domes 98 and grow lights with vents 96 (see FIG. 28). Grow lights were operated on a timer for 15 consecutive hours a day starting at 5:30 a.m. The date the seeds were planted is noted (7/31). Seedling were then treated 12 days after planting as noted (8/12) with the following conditions. Nine groups were studied, where seedling trays were dedicated to only one of these groups per tray. Group 1 (2 plants) was left untreated, without pellets or pesticides. Group 2 (6 plants) was treated with Alg-N-AEMI-Ca-Crosslinked-Pellets applied at a rate of 7 pellets per plant. Group 3 (7 plants) was treated with 0.096 mg N-(2,4-dichlorophenoxyacetyl)-L-cysteine (Cys-2,4-D 74) per plant (100 μL of solution with 0.96 mg Cys-2,4-D per mL PBS and 10 μL of 10% aq. NaOH per mL of PBS, 0.40 lb acid equivalent per acre). Group 4 (12 plants) was treated with Cys-2,4-D-Conjugated-Alg-N-AEMI-Ca-Crosslinked-Pellets that were linked in the soil. In soil linking was achieved as follows: Alg-N-AEMI-Ca-Crosslinked-Pellets were applied at a rate of 7 pellets per plant. 0.096 mg N-(2,4-dichlorophenoxyacetyl)-L-cysteine (Cys-2,4-D 74) per plant (100 μL of solution with 0.96 mg Cys-2,4-D per mL PBS and 10 μL of 10% aq. NaOH per mL of PBS, 0.40 lb acid equivalent per acre) was then applied to the pellets and plants. Group 5 (7 plants) was treated with Cys-2,4-D-Conjugated-Alg-N-AEMI-Ca-Crosslinked-Pellets that were linked in the soil. In soil linking was achieved as follows: Alg-N-AEMI-Ca-Crosslinked-Pellets were applied at a rate of 7 pellets per plant. 0.0192 mg N-(2,4-dichlorophenoxyacetyl)-L-cysteine (Cys-2,4-D 74) per plant (100 μL of solution with 0.192 mg Cys-2,4-D per mL PBS and 2 μL of 10% aq. NaOH per mL of PBS, 0.08 lb acid equivalent per acre) was then applied to the pellets and plants. Group 6 (12 plants) was treated with Cys-2,4-D-Conjugated-Alg-N-AEMI-Ca-Crosslinked-Pellets that were linked in the soil. Alg-N-AEMI-Ca-Crosslinked-Pellets were applied at a rate of ˜7 pellets per plant. 0.0096 mg N-(2,4-dichlorophenoxyacetyl)-L-cysteine (Cys-2,4-D 74) per plant (100 μL of solution with 0.096 mg Cys-2,4-D per mL PBS and 1 μL of 10% aq. NaOH per mL of PBS, 0.04 lb acid equivalent per acre) was then applied to the pellets and plants. Group 7 (5 plants) was treated with 0.25 mg 2,4-D per plant (100 μL of solution with 2.5 mg 2,4-D per mL PBS and 10 μL of 10% aq. NaOH per mL of PBS, 1.5 lb 2,4-D per acre). Group 8 (14 plants) was treated with 0.025 mg 2,4-D per plant (100 μL of solution with 0.25 mg 2,4-D per mL PBS and 1 μL of 10% aq. NaOH per mL of PBS, 0.15 lb 2,4-D per acre). And Group 9 (7 plants) was treated with 0.05 mg 2,4-D per plant (100 μL of solution with 0.5 mg 2,4-D per mL PBS and 2 μL of 10% aq. NaOH per mL of PBS, 0.30 lb 2,4-D per acre). All plants were watered on the dates where plant survival was assessed (every 3 days) with 0.5 mL of water per plant. Groups 1, 2, 5, 6, and 9 maintained 100% survival throughout the study. Both Group 7, the plants treated 0.25 mg 2,4-D per plant (100 μL of solution with 2.5 mg 2,4-D per mL PBS and 10 μL of 10% aq. NaOH per mL of PBS, 1.5 lb 2,4-D per acre) and Group 4, the plants treated with Cys-2,4-D-Conjugated-Alg-N-AEMI-Ca-Crosslinked-Pellets linked in the soil using 0.096 mg N-(2,4-dichlorophenoxyacetyl)-L-cysteine (Cys-2,4-D 74) per plant (100 μL of solution with 0.96 mg Cys-2,4-D per mL PBS and 10 μL of 10% aq. NaOH per mL of PBS, 0.40 lb acid equivalent per acre) were comparable and had the lowest two % survival by the end of this study.

### II. Definitions

“On-demand” refers to the preparation of a controlled release system by the end user either in the plant growth medium or immediately prior to application. The end user is provided with control over what pesticide or pesticides to include in the controlled release system, when to include them, and how much to include. The control release system can also be replenished on-demand. In contrast to the on-demand controlled release system, other technologies that are NOT on-demand commit to the choice of pesticide or pesticides formulated on manufacture or during the in vitro preparation of the controlled release system, including a commitment to a release rate or rates and percent pesticide or pesticides in the controlled release formulation. Control release systems that are NOT on-demand cannot be adjusted by the end user in the plant growth medium or prior to application.

“Pesticide” as employed herein is any active material used for biologic control of unwanted organisms including in particular herbicides, insecticides, fungicides, nematocides and other biocides, and includes plant growth regulators and the like materials. The pesticides that may be used with the present invention are those pesticides which have an active hydrogen or which can be modified to have an active hydrogen which can be used as a means of achieving a cleavable linkage with a linker or directly bonding to a binding agent. The active hydrogen atom may be coupled directly to an oxygen, nitrogen, or sulfur atom which maybe within a substituent group consisting of hydroxyl, sulfhydryl, amino, imino, carboxyl, amido, imido, sulfonamido, sulfonimido, phosphoramido, phosphorimido, thiophosphoramido, or thiophosphorimido.

Representative of the pesticides which may be employed as starting materials in the process are the following:
2-Ethylamino-4-isopropylamino-6-methylthio-1,3,5-triazine
3-Amino-5-triazole
Ammonium sulfamate
Arsenic acid
Methyl sulfanilyl carbamate
2-Chloro-4-(ethylamino)-6-(isopropylamino)-s-triazine
(4-Chloro-2-butynyl N-3(-chlorophenyl) carbamate
4-Chloro-2-oxobenzothiazolin-3-ylacetic acid
N-Butyl-N-ethyl-∝,∝,∝-trifluoro-2,6-dinitro-p-toluidine
S—(O,O-diisopropyl phosphorodithioate) ester of N-(2-mercaptoethyl) benzene sulfonamide
3-Isopropyl-1H-2,1,3-benzothiadiazin-4-(3H)-one 2,2-dioxide
(Benzamidooxy)acetic acid
Methyl 5-(2,4-dichlorophenoxy)-2-nitrobenzoate
5-Bromo-3-sec-butyl-6-methyluracil
3,5-Dibromo-4-hydroxybenzonitrile
Hydroxydimethylarsine oxide
D-N-Ethylactamide carbanilate (ester)
3-Amino-2,5-dichlorobenzoic acid
3-(4-Bromo-3-chlorophenyl)-1-methoxy-1-methylurea
Methyl-2-chloro-9-hydroxyfluorene-9-carboxylate
3-(p-(p-Chlorophenoxy)phenyl)-1,1-dimethylurea
Isopropyl-m-chlorocarbanilate
(2-[[4-Chloro-6-(ethylamino)-s-triazin-2-yl]amino]-2-methylpropionitrile)
2-Chloro-4-(cyclopropylamino)-6-(isopropylamino)-s-triazine
(2,4-Dichlorophenoxy)acetic acid
2,2-Dichloropropionic acid
4-(2,4-Dichlorophenoxy)butyric acid
Ethyl m-hydroxycarbanilate carbanilate
3,6-Dichloro-o-anisic acid
2-(2,4-Dichlorophenoxy)propionic acid
N,N-Diethyl-∝,∝,∝-trifluoro-3,5-dinitrotoluene-2,4-diamine
2-sec-Butyl-4,6-dinitrophenol
2,4-Bis(isopropylamino)-6-(ethylthio)-s-triazine
3-(3,4-Dichlorophenyl)-1,1-dimethylurea
7-Oxabicyclo[2,2,1]heptane-2,3-dicarboxylic acid
2-Chloroethylphosphonic acid
(2,3,6-Trichlorophenyl)acetic acid
1,1-Dimethyl-3-phenylurea mono(trichloroacetate)
1,1-Dimethyl-3-(∝,∝,∝-trifluoro-m-tolyl)urea
Butyl 9-hydroxyfluorene-9-carboxylate
N-(Phosphonomethyl)glycine
N,N-Bis(phosphonomethyl)glycine
2-Methoxy-4-ethylamino-6-sec-butylamino-s-triazine
4-Hydroxy-3,5-diiodobenzonitrile
3-(m-Hydroxyphenyl)-1,1-dimethylurea
3-(3,4-Dichlorophenyl)-1-methoxy-1-methylurea
Methanearsonic acid
N-3-(1,1,1-Trifluoromethylsulfonyl)Amino-4-methylphenyl)acetamide
1,1,1-Trifluoro-N-2-methyl-4-(phenylsulfonyl)phenylmethanesulfonamide
2-Methyl-4-chlorophenoxyacetic acid
4-(4-Chloro-o-tolyl)oxybutyric acid
2-(4-Chloro-o-tolyl)oxypropionic acid
4-Amino-6-tert-butyl-3-(methylthio)-as-triazin-5(4H)-one
1,2-Dihydro-3,6-pyridazinedione
3-(p-Chlorophenyl)-1,1-dimethylurea
1-Naphthalene acetic acid
N-1-Naphthylphthalamic acid
6-tert-Butyl-3-isopropylisoxazolo-5,4-dipyrimidin-4(5H)-one
3-(Hexahydro-4,7-methanoindan-5-yl)-1,1-dimethylurea
4-Chloro-5-(methylamino)-2-[3-(trifluoromethyl)phenyl]pyridazin-3-one
3,5-Dinitro-N,N′-dipropylsulfanilamide
Methyl m-hydroxycarbanilate m-methylcarbanilate
4-Amino-3,5-6-trichloropicolinic acid
p-Chlorophenyl N-methylcarbamate
2,4-Bis(isopropylamino)-6-methoxy-s-triazine
2,4-Bis(isopropylamino)-6-(methylthio)-s-triazine
N,-(1,1-Dimethylpropynyl)-3,5-dichlorobenzamide
3′,4′-Dichloropropionanilide
2-Chloro-4,6-bis(isopropylamino)-s-triazine
Isopropyl carbanilate
5-Amino-4-chloro-2-phenyl-3(2H)-pyridazinone
1-(2-Methylcyclohexyl)3-phenylurea
2-(2,4,5-Trichlorophenoxy)propionic acid
2-Chloro-4,6-bis(ethylamino)-s-triazine
(2,4,5-Trichlorophenoxy)acetic acid
2,3,6-Trichlorobenzoic acid
Trichloracetic acid
3-tert-Butyl-5-chloro-6-methyluracil
2-Chloro-4-ethylamino-6-tert-butylamino-s-triazine
2,6-Di-tert-butyl-p-tolyl methylcarbamate
2-Methylthio-4-ethylamino-6-tert-butylamino-s-triazine
2,3,5-Triiodobenzoic acid
S-(2,3,3-Trichloroallyl)diisopropylthiocarbamate
S-Propyl dipropylthiocarbamate
Acroeline phenylhydrazone
2-Amino-3-chloro-1,4-naphthoguinone
4-Amino-pteroylglutamic acid
1-(6-Chloro-3-pyridylmethyl)-N-nitroimidazolidin-2-ylideneamine
2,2-Dimethyl-2,3-dihydro-1-benzofuran-7-yl methylcarbamate
p-tert-Amyl phenol
2-(3′-Pyridyl) piperidine
2,4-Dichloro-6-(2-chloroanil-o)-1,3,5 triazine
1-Decanol
1-(1-Naphthyl)-2-thiourea
2-Iodobenzanilide
1,4-Benzoquinone-1-benzoyl-hydrozone-4-oxime
4-Chloro-3,5-xylenol
n-Butyl-p-hydroxybenzoate
Benzoyl-8-hydroxyquinoline salicylate
3-(sec-Butyl) phenyl-N-methylcarbamate
3,5-Dibromo-4-hydroxybenzaldehyde 2,4-dinitrophenyl oxime
2-Bromo-4′-hydroxyacetophenone
Isopropyl 4,4′-dibromobenzilate
3,5-Dibromo-4-hydroxybenzonitrile
2-Ethyl-2-butyl-1,3-propanediol
1-Naphthyl methylcarbamate
2,3-Dihydro-2,2-dimethyl-benzofuran-7-yl-methylcarbamate
Chlorobenzenesulfonamide
Monochloroacetic acid
cis-3-Chloroacrylic acid
3-Amino-2,5-dichlorobenzoic acid
2,2′-Thiobis(4-chloro-6-methylphenol)
3-(4-Bromo-3-chlorophenyl)-1-methoxy-1-methylurea
1-Methyl-2-propynyl-m-chlorocarbanilate
Ethyl 4,4′-dichlorobenzilate
4-Chloro-m-cresol
4-Chloro-2-cyclopentyl phenol
5-Chloro-4-methyl-2-propionamidothiazole
2,2,3-Trichloropropionic acid
Isopropyl 4,4′-dichlorobenzilate
6-Chlorothymol
3,5-Dichloro-4-hydroxybenzonitrile
O-Benzyl-p-chlorophenol
3-(o-Acetonyl-4-chlorobenzyl)-4-hydroxycoumarin
2-(3-Chlorophenoxy)propionamide
2-(3-Chlorophenoxy)propionic acid
2-Chlorophenyl-N-methylcarbamate
2-(4-Chlorophenoxy)propionic acid
O-Cresol
m-Cresol
p-Cresol
∝-Cyano-B-(2,4-dichloro)-cinnamic acid
N-Cyclohexyl 2,5-dimethyl-3-furamide
3-(4-Cyclopropylphenyl)-1,1-dimethylurea
3-Cyclo-octyl-1,1-dimethylurea
0,0-Dimethyl O-p-sulfamoylphenyl phosphorothioate
2,2-Dichloropropionic acid
1,3-Bis(1-hydroxy-2,2,2-trichloroethyl)urea
3,6-Dichloro-2-methoxybenzoic acid
2,2-Methylenebis(4-chlorophenol)
2,4-Dichlorophenoxyacetamide
2(3,4-Dichlorophenoxy)propionic acid
1,1-Bis(p-chlorophenyl)-2,2,2-trichlorethanol
O,O-Dimethyl S—(N-methyl-carbamoylmethyl) phosphorodithioate
4,6-Dinitro-o-cresol
2,4-Dinitro-6-cyclohexyl phenol
2,4-Dinitrophenol
2,5-Dichloro-3-nitrobenzoic acid
2,4-Dinitro-6-sec-butylphenol
2,4-Dinitro-6-tert-butylphenol
1,1-Bis(p-chlorophenyl)ethyl carbinol
Fluoroacetamide
Fluoroacetanilide
3-Hydroxy-5-methylisoxazole
2-Hydroxymethyl-4-chlorophenyloxyacetic acid
3-Indolepropionic acid
4-Chloro-2-methylphenoxyacetic acid
4-(4-Chloro-2-methylphenoxy)butyric acid
3-Methyl-2,4-dinitro-6-tertbutyl phenol
Bishydroxycoumarin
Methyl p-hydroxybenzoate
Cyclopentane carboxylic acid
2-Naphthol
∝,∝-Bis(p-chlorophenyl)-3-pyridinemethanol
Nonylic acid
2,3,4,5,6-Pentachlorobenzylalcohol
Pentachlorophenol
2-Phenylcyclohexanol
2-Hydroxy diphenyl N-phenyl-N′-3-thiolane-1-dioxide hydrazide
4-Amino-3,5,6-trichloropiccdinic acid
2-Hydroxybenzhydroxamic acid
2,4-Hexadienoic acid
1,1′-Methylenedi-2-naphthol
2,3,6-Trichlorobenzoic acid
3,4,5-Tribromosahcylanilide
3-Trifluoromethyl-4-nitrophenol
2,3,5-Triiodobenzoic acid
3,5,6-Trichloro-2-methoxybenzoic acid
2,4,6-Trichlorophenol
2,4,5-Trichlorophenol
2-(Hydroxymethyl)-2-nitrol-1,3-propanediol
2,3,6-Trichlorobenzyloxypropanol
10-Undecenoic acid
2,4-Dimethylphenol
Avermectin
[(R)-Cyano-(3-phenoxyphenyl)methyl](1S,3S)-3-[(Z)-2-chloro-3,3,3-trifluoroprop-1-enyl]-2,2-dimethylcyclopropane-1-carboxylate

The foregoing list is not complete, and as indicated previously any pesticide having an active hydrogen, or which can be modified to have an active hydrogen may be employed.

“Controlled release system” refers to a composition that includes at least one pesticide and is capable of releasing the pesticide into the application environment at a lower rate than the pesticide would be released if applied without being included in the composition.

“Controllably releases” refers to the release of pesticide into the application environment at a lower rate than the pesticide would be released if applied without being included in the control release system.

“Application environment” refers to an environment immediately surrounding the controlled release system or the receptive biocompatible solid support in which it is desired that the pesticide demonstrate its pesticidal effect. This is normally the environment in which the controlled release system would be expected to encounter the pest that it is designed to control.

An “effective amount” of pesticide is a concentration at which the pesticide is effective to protect against the target pest.

“Plant growth medium” refers to the mixture of components that provide water, air, nutrients and support to plants. Suitable plant growth media that may be included in the plant growth medium include but is not limited to natural soil, soil found in an agricultural field, soil found in a lawn, soil mixtures, vermiculite, sand, perlite, peat moss, clay, wood bark, coir, sawdust, fly ash, pumice, plastic particles, glass wool, rock wool, and polyurethane foams, and combinations thereof.

“Biocompatible solid support” refers to a solid support material capable of being applied in the plant growth medium and supporting one of the binding agents, as well as the pesticide after the binding agents link. The solid support is compatible with plants and other organisms found in the plant growth medium. It can be in contact with a living system without producing an adverse effect. Representative biocompatible solid supports include, but are not limited to, hydrogels such as polysaccharide hydrogels, alginate, cellulose, hyaluronic acid, chitosan, chitin, chondroitin sulfate, heparin, a polymer matrix, crosslinked polyacrylic acid, zein, a metal, a ceramic, an organoclay, a plastic and others.

“Linking chemistry” is a chemical reaction or reactions to form at least one covalent bond between two compounds.

“Click chemistry” is linking chemistry that meets specific criteria including high yield, fast reaction rates, and minimal byproducts.

“Bioorthogonal chemistry” refers to any chemical reaction that can occur inside of living systems without interfering with native biochemical processes.

“Biocompatible chemistry” refers to non-enzymatic chemical reactions that take place under mild conditions compatible with living organisms.

“Bioconjugation” is a chemical reaction or reactions to form at least one covalent bond between two compounds, at least one of which is a biomolecule.

“Binding agent” refers to any group capable of forming at least one covalent bond to another binding agent in a plant growth medium. This can include but is not limited to click chemistry, bioconjugation or bioorthogonal chemistry. Representative binding agents include, but are not limited to, a thiol and a maleimide, a furan and a maleimide, an amine and an activated ester, an amine and an isocyanate, an amine and an isothiocyanate, thiols for formation of disulfides, an azide for formation of an amide via a Staudinger ligation, an azide and alkyne for formation of a triazole, trans-cyclooctene (TCO) and tetrazine, and others.

“Pesticide formulation” refers to a mixture of chemicals which when contacted with a receptive biocompatible solid support can effectively control a pest. Formulating a pesticide involves processing it to improve its application, effectiveness, storage, handling, and safety. A discussion of herbicide formulation can be found in “Herbicide Formulation” R. L. Zimdahl, Fundamentals of Weed Science 2018, 501-509.

“Linker”, “linked” “linking” or “conjugated” refers to a chemical moiety that links a compound of the present invention to another compound, including biocompatible solid supports, pesticides and binding agents. The linking can be via covalent or ionic bond formation. The linking can be direct linkage between the two moieties being linked, or indirectly, such as via a linker. Any suitable liker can be used. Linkers useful in the present invention can be up to 30 carbon atoms in length. Preferably, the linkers are 2-15 carbon atoms in length. Representative linkers can have about 2 to about 100 linking atoms, and can include oxyethylene groups, thioethers, amines, esters, amides, imides and ketone functional groups. The types of bonds used to link the linker to a compound of the present invention include, but are not limited to, amides, amines, esters, carbamates, ureas, thioethers, thiocarbamates, thiocarbonate and thioureas. One skilled in the art will appreciate that other types of bonds are useful in the present invention. The bonds used to link the linker to a compound of the present invention can be cleavable linkages, and in embodiments where the linking is direct linkage between the two moieties being linked the direct linkage can be a cleavable linkage.

“Cleavable linkage” refers to a linkage that is cleaved under environmental conditions. Examples of cleavable linkages include esters and amides that are cleaved through hydrolysis either by enzymes, through the action of water or other chemical means; hydrazones, acetals, ketals, oximes, imine, aminals and similar groups that are cleaved through hydrolysis; disulfide linkers that are cleaved through reduction by free thiols and other reducing agents; peptide linkers that are cleaved through the action of proteases and peptidases; nucleic acid linkers cleaved through the action of nucleases.

“Contacting”, “contact” or “contacted” refers to the process of bringing into contact at least two distinct species such that they can react. It should be appreciated, however, that the resulting reaction product can be produced directly from a reaction between the added reagents or from an intermediate from one or more of the added reagents which can be produced in the reaction mixture.

“Pest” refers to any animal, plant, microbe or other organism whose biology, behavior, or location places it in direct conflict with humans.

### III. Compositions

In some embodiments, the present invention provides an agrochemical formulation composition comprising a conjugating agent 46 and agrochemical carriers and co-formulants, wherein the conjugating agent 46 comprises a pesticide 50 linked to a second binding agent 54 and the link involves a cleavable linkage to the pesticide 50, wherein the conjugating agent 46 links to a receptive biocompatible solid support 44 comprised of a biocompatible solid support 40 linked to a first binding agent 42 that links to the second binding agent 54 of the conjugating agent 46 to form the controlled release system 48, wherein a cleavable linkage to pesticide 50 is cleaved under environmental conditions, and therefore the controlled release system 48 controllably releases an effective amount of pesticide 50 to the application environment 59 where it is desired that the pesticide demonstrate its pesticidal effect. In one embodiment, the pesticide 50 has an active hydrogen or which can be modified to have an active hydrogen which can be used as a means of achieving a cleavable linkage with a linker or directly bonding to a binding agent. In another embodiment, the pesticide 50 is a biocide. In another embodiment the pesticide 50 is an herbicide.

### IV. Formulation

The compositions of the present invention can be prepared in a wide variety of pesticide formulations. Formulating a pesticide involves processing it to improve its application, effectiveness, storage, handling, and safety (for a discussion of herbicide formulation see “Herbicide Formulation” R. L. Zimdahl, Fundamentals of Weed Science 2018, 501-509.)

### V. Method of Pesticide Delivery

The present invention provides a method for delivering a pesticide 50 to an application environment 59 in a plant growth medium 58 using a controlled release system 48. The controlled release system 48 controllably releases pesticide 50 to the application environment 59 where it is desired that the pesticide 50 demonstrate its pesticidal effect. This is normally the environment in which the controlled release system 48 would be expected to encounter the pest that it is designed to control. In some embodiments, the present invention provides a method for selectively delivering an effective amount of a pesticide 50 to a pest in a plant grown medium 58, including steps to link a biocompatible solid support 40 to a pesticide 50, wherein the biocompatible solid support 40 is linked to a first binding agent 42, the resulting receptive biocompatible solid support 44 is then contacted with a second binding agent 54 linked to a pesticide 50 and the link involves a cleavable linkage to the pesticide 50, the conjugating agent 46, to obtain a controlled release system 48, wherein the controlled release system 48 targets an application environment 59, including without any limitation application environments 59 in agricultural fields. In some embodiments the application environment 59 is in a lawn.

Any suitable biocompatible solid support 40 can be used in the method of the present invention. For example, the biocompatible solid support 40 can be a hydrogel, a crosslinked polymer matrix, a metal, a ceramic, a plastic, among others. Hydrogels useful in the present invention include, but are not limited to, polysaccharide hydrogels, alginate, cellulose, hyaluronic acid, chitosan, chitosin, chitin, hyaluronic acid, chondroitin sulfate, heparin, and others. Polymers useful as the biocompatible support can include, but are not limited to, polyacrylic acids, polyphosphazenes, polyanhydrides, polyacetals, poly(ortho esters), polyphosphoesters, polycaprolactones, polyurethanes, polylactides, polycarbonates, polyamides, and polyethers, and crosslinked polymers/blends/composites/co-polymers thereof. Representative polyethers include, but are not limited to, poly(ethylene glycol) (PEG), polypropylene glycol) (PPG), triblock Pluronic ([PEG]n-[PPG]m-[PEG]n), PEG diacrylate (PEGDA) and PEG dimethacrylate (PEGDMA). The biocompatible solid support can also include proteins and other poly(amino acids) such as collagen, gelatin, elastin and elastin-like polypeptides, albumin, fibrin, poly(gamma-glutamic acid), poly(L-lysine), poly(L-glutamic acid), poly(aspartic acid), and zein.

Any suitable binding agent (first binding agent 42 and second binding agent 54) can be used in the method of the present invention. Representative binding agents can be found in “Bioconjugate Techniques” Greg T. Hermanson, 2013, Angew Chem Int Ed Engl. 2009, 48, 6974-6998, and Chem Biol. 2014, 21, 1075-1101. For example, binding agents useful in the method of the present invention include, but are not limited to, thiol, maleimide, furan, cyclooctene, tetrazine, azide, alkyne, isonitrile, amine, activated ester, isocyanate, isothiocyanate, aldehyde, and others. In some embodiments, the first binding agent 42 and the second binding agent 54 can each independently be thiol, maleimide, furan, azide or alkyne. In some embodiments, the first binding agent 42 and the second binding agent 54 can each independently be maleimide or thiol, such that one of the binding agents is maleimide and the other is thiol. In some embodiments, the first binding agent 42 and the second binding agent 54 can each independently be maleimide and furan, such that one of the binding agents is maleimide and the other is furan. In some embodiments, the first binding agent 42 and the second binding agent 54 can each independently be azide or alkyne, such that one of the binding agents is azide and the other is alkyne.

In some embodiments, the second binding agent 54 can be covalently linked to the pesticide 50. The second binding agent 54 can covalently bind directly pesticide 50 or indirectly via the use of a linker 52. Any suitable linker 52 can be used in the present invention to link the second binding agent 54 to the pesticide 50. Linkers useful in the present invention can be up to 30 carbon atoms in length. Preferably, the linkers are 2-15 carbon atoms in length. Representative linkers can have about 2 to about 100 linking atoms, and can include oxyethylene groups, thioethers, amines, esters, amides, imides and ketone functional groups. The types of bonds used to link the linker 52 to a compound of the present invention include, but are not limited to, amides, amines, esters, carbamates, ureas, thioethers, thiocarbamates, thiocarbonate and thioureas. One skilled in the art will appreciate that other types of bonds are useful in the present invention. The bonds used to link the linker to a compound of the present invention can be cleavable linkages, and in embodiments where the linking is direct linkage between the two moieties being linked the direct linkage can be a cleavable linkage.

### VI. Method of Treating

In another embodiment, the present invention provides a method for treating a pest. The method comprises applying to a plant growth medium 58 in need of such treatment an effective amount of pesticide 50 provided by the controlled release system 48. In one embodiment, the pest is a plant 56. In one embodiment, the plant 56 is a weed. The present invention provides a method of treating a pest in a plant growth medium 58 using the method described above. In some embodiments, the present invention provides a method of treating a pest in a plant growth medium 58, including applying to the plant growth medium 58 a biocompatible solid support 40 linked to a first binding agent 42, applying to the plant growth medium 58 a pesticide formulation of a conjugating agent 46 that comprises a pesticide 50 linked to a second binding agent 54 and the link involves a cleavable linkage to the pesticide 50, such that the two binding agents are contacted and link, and the controlled release system 48 is formed. A cleavable linkage to pesticide 50 is cleaved under environmental conditions, and therefore the controlled release system 48 controllably releases an effective amount of pesticide 50 to the application environment 59 where it is desired that the pesticide demonstrate its pesticidal effect. This is normally the environment in which the controlled release system 48 would be expected to encounter the pest that it is designed to control.

### VII. Alternative Embodiments

In an alternative embodiment the sequence of steps can be altered such that:
In one alternative embodiment, a receptive biocompatible solid support 44 is prepared by linking a biocompatible solid support 40 to a first binding agent 42. A conjugating agent 46 is prepared by linking a pesticide 50 to a second binding agent 54 and the link involves a cleavable linkage to the pesticide 50. The receptive biocompatible solid support 44 is combined with conjugating agent 46 or pesticide formulations thereof to form the controlled release system 48. The controlled release system 48 is then applied to the plant growth medium 58. A cleavable linkage to the pesticide 50 in the controlled release system 48 cleaves under environmental conditions, and therefore the controlled release system 48 controllably releases an effective amount of pesticide 50 to the application environment 59 where it is desired that the pesticide 50 demonstrate its pesticidal effect. This is normally the environment in which the controlled release system would be expected to encounter the pest that it is designed to control.

In another alternative embodiment, the controlled release system can be applied to a growth medium other than a plant growth medium.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

### EXAMPLES

All reagents and NMR solvents were purchased from Sigma-Aldrich (St. Louis, MO), TCI America (Montgomeryville, PA), Ambeed (Arlington Heights, IL), and Grainger (Bethlehem, PA), unless otherwise noted. Sodium alginate was purchased from bioWORLD (Dublin, OH).

NMR experiments were carried out in D₂O or DMSO-d6, using a Bruker 400 MHz Spectrometer. HPLC analyses were performed on an HP1050 HPLC system equipped with a Variable Wavelength Detector set to 228 nm. The Column used was a Kromasil 100-10PHENYL 250×4.6 mm E22530. The solvent system was isocratic and composed of H₂O with 0.1% trifluoroacetic acid and methanol (H₂O w/0.1% TFA:MeOH 40:60), flowing at 2 mL per minute.

Optical densities (O.D.) were measured on an Absorbance Microplate Reader: Dynex Technologies, MRX Revelation 96-well microplate reader.

Plants were grown in Seedling Trays with Humidity Domes and Grow lights (Yskea Store—Amazon.com) placed on seedling heat mats (VIVOSUN, Amazon.com).

Sinapis arvensis (wild mustard) seeds were obtained from GIFTfromNATURE (Burgas, Bulgaria).

### Example 1: Preparation of an Alginate Linked to Maleimide (Alg-N-AEMI 66, See Below)

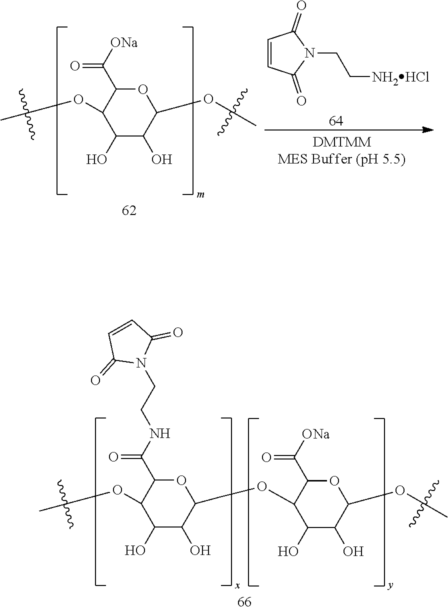

200 mg of sodium alginate 62 combined with 18 mL of (2-(N-morpholino)ethanesulfonic acid (MES) buffer (0.1 M, pH 5.5) in a 50 mL Corning Centrifuge Tube and stirred at room temperature for 1 hour to dissolve the alginate. 138 mg of 4-(4,6-dimethoxy-1,3,5-triazin-2-yl)-4-methylmorpholinium chloride (DMTMM) was then added and the mixture stirred at room temperature for 30 minutes. A solution N-(2-aminoethyl)maleimide hydrochloride 64 (50 mg) in 2 mL of MES buffer (0.1 M, pH 5.5) was prepared and added dropwise to the reaction mixture. The reaction mixture was capped and stirred at room temperature for 5 days. The reaction mixture was then transferred to an Erlenmeyer flask equipped with a stir bar. 40 mL of 91% isopropanol was slowly added to the mixture with stirring to precipitate the alginate. The gum/gel was collected and then redissolved in 20 mL of water (stirred overnight at room temperature). 60 mL of 91% isopropanol was then added to precipitate the alginate. The gum/gel was collected and dried under vacuum to obtain Alg-N-AEMI 66. 21.4 mg of the material thus obtained, Alg-N-AEMI 66, was dissolved in 1 mL of D₂O and analyzed by NMR at 50° C. The 1H NMR spectrum is provided in FIG. 14 and is consistent with the published spectrum (A. Golunova, N. Velychkivska, Z. Mikšovská, V. Chochola, J. Jaroš, A. Hampl, O. Pop-Georgievski and V. Proks, Int. J. Mol. Sci. 2021, 22, 5731). 1H-NMR Integration reveals: 2 (vinyl maleimide protons at ˜7.2 ppm) to 37.2 (maleimide linker (4 protons) and saccharide alcohol methines (3 per saccharide) 3.4 to 4.6 ppm). When adjusted by subtracting the estimated integration value for linker protons: 2 (vinyl maleimide 6.9 ppm) to 33.2 (saccharide alcohol methines (3 per saccharide) 3.4 to 4.6 ppm). Ratio Maleimide:Saccharide=1:11.06 (Maleimide is 6.73 wt %), Degree of Modification (DM)=9.04%.

### Example 2: Preparation of an Alginate Linked to Maleimide (Alg-N-AEMI 66, See Below)

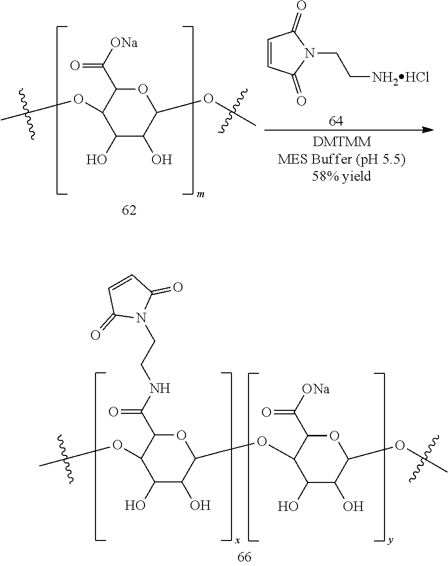

2 g of sodium alginate 62 combined with 180 mL of MES buffer (0.1 M, pH 5.5) in a 500 mL Erlenmeyer Flask with a screw-type cap and stirred at room temperature overnight to dissolve the alginate. 1.38 g of DMTMM was then added and the mixture stirred at room temperature for 30 minutes. A solution N-(2-aminoethyl)maleimide hydrochloride 64 (0.5 g) in 20 mL of MES buffer (0.1 M, pH 5.5) was prepared and added dropwise to the reaction mixture. The reaction mixture was capped and stirred at room temperature for 23 hours. The reaction mixture was then transferred to an Erlenmeyer flask equipped with a stir bar. 600 mL of 91% isopropanol was slowly added dropwise through a separatory funnel to the mixture with stirring to precipitate the alginate. The gum/gel was collected by filtering the mixture through a glass fritted filter funnel, and washed with 2×50 mL of ethanol to obtain a white solid. This material was placed under high vacuum overnight to obtain 1.46 g of Alg-N-AEMI 66 (58% yield). 35 mg of the material thus obtained, Alg-N-AEMI 66, was dissolved in 1 mL of D₂O and analyzed by NMR. The 1H NMR spectrum was consistent with the published spectrum (A. Golunova, N. Velychkivska, Z. Mikšovská, V. Chochola, J. Jaroš, A. Hampl, O. Pop-Georgievski and V. Proks, Int. J. Mol. Sci. 2021, 22, 5731).

### Example 3: Preparation of N,N′-Bis-(2,4-Dichlorophenoxyacetyl)-L-Cystine 72 (See Below)

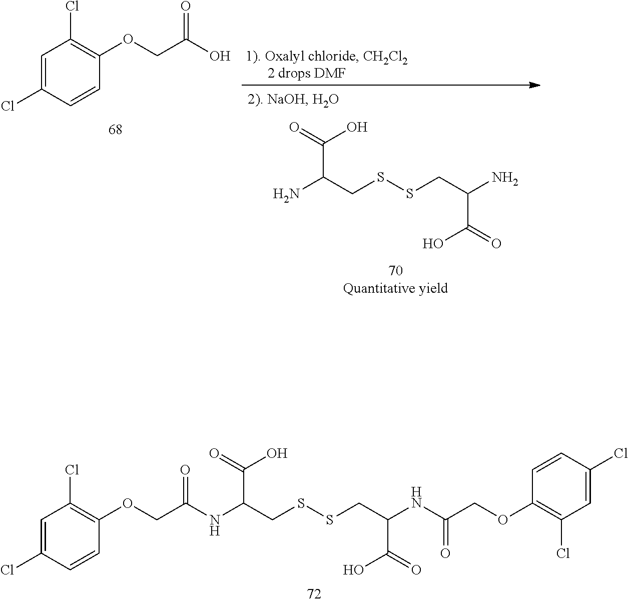 [SMILES: O=C(O)COc1ccc(Cl)cc1Cl ; NC(CSSCC(N)C(=O)O)C(=O)O ; O=C(COc1ccc(Cl)cc1Cl)NC(CSSCC(NC(=O)COc1ccc(Cl)cc1Cl)C(=O)O)C(=O)O]

Charged 663 g of 2,4-D 68 to a 20 mL vial equipped with a magnetic stir bar, then added 6 mL of dichloromethane and 2 drops of dimethylformamide, and then cooled in an ice water bath under a nitrogen atmosphere. Prepared a solution of 508 μL of oxalyl chloride in 3 mL of dichloromethane and added dropwise to the cooled 2,4-D 68 solution. Capped the vial and removed the reaction mixture from the ice water bath. Stirred at room temperature for 1 hr, then concentrated the reaction mixture in vacuo on a rotary evaporator. Dissolved residue in 2 mL of toluene to obtain a solution of 2,4-D-derived acid chloride. Prepared a solution of 364 mg of L-cystine 70 in 5.4 mL of water and combined with 3.6 mL of 10% aq. NaOH in a 50 mL Corning Centrifuge Tube equipped with a magnetic stir bar and cooled in an ice water bath. Added the toluene acid chloride solution to the cooled L-cystine 70 solution dropwise and rinsed and transferred residual acid chloride from the vial to the L-cystine 70 solution with another 1 mL of toluene. The resulting reaction mixture in the centrifuge tube was capped, removed from the ice water bath and stirred at room temperature for 2 hours. The resulting mixture was transferred to a separatory funnel and extracted with 100 mL of methyl-tert-butyl ether. The aqueous layer was collected and acidified to a pH of ˜1 by adding 7 mL of 2 M aq. HCl to obtain a cloudy white mixture. 10 mL of water was added to further force out material from the solution. The resulting mixture was filtered through filter paper and washed with 4×20 mL of water. The solids thus obtained were dissolved in hot ethanol (˜9 mL), and then precipitated by the addition of 5 mL of hot water. The mixture was cooled in an ice water bath and filtered through filter paper to obtain a white solid. The white solid was placed under high vacuum overnight to obtain 1.3213 g of wet N,N′-bis-(2,4-dichlorophenoxyacetyl)-L-cystine 72 (quantitative yield). The material thus obtained was analyzed by NMR. The 1H NMR spectrum is provided in FIG. 6 and the 13C NMR spectrum is provided in FIG. 7. This procedure was adapted from a published preparation, see J. W. Wood and T. D. Fontaine, J. Org. Chem. 1952, 17, 891-896.

### Example 4: Preparation of N-(2,4-Dichlorophenoxyacetyl)-L-Cysteine 74 (Cys-2,4-D, See Below)

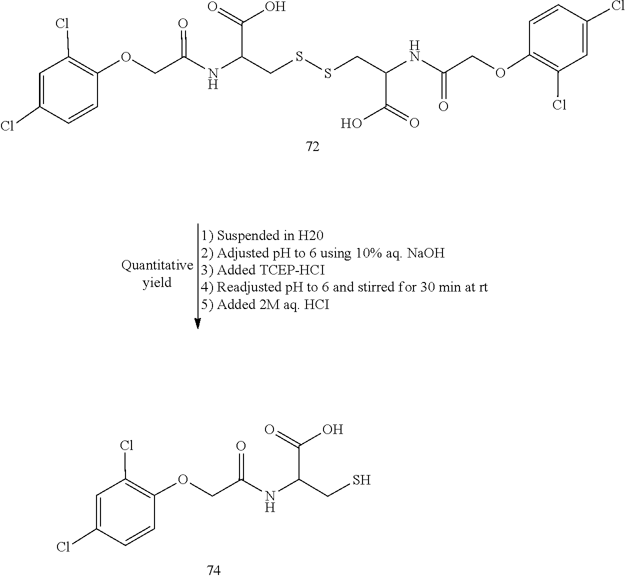 [SMILES: O=C(COc1ccc(Cl)cc1Cl)NC(CSSCC(NC(=O)COc1ccc(Cl)cc1Cl)C(=O)O)C(=O)O ; O=C(COc1ccc(Cl)cc1Cl)NC(CS)C(=O)O]

N,N′-Bis-(2,4-dichlorophenoxyacetyl)-L-cystine 72 was suspended in 5 mL of water, and then combined with 1 mL of 10% aq. NaOH. The solids go into solution (mixture is homogeneous). Then added 8 mL of TCEP hydrochloride, and the precipitate appears. Gradually added 4.8 mL of 10% NaOH to bring the precipitate back into solution (pH=˜6). Stirred reaction mixture at room temperature for 30 minutes, then transferred to a 50 mL Corning Centrifuge Tube and acidified with 20 mL of 2 M aq. HCl. White solids appear. Filtered the mixture through filter paper and washed with 4×40 mL of water to obtain wet N-(2,4-dichlorophenoxyacetyl)-L-cysteine 74 (quantitative yield). Due to facile disulfide formation, the quality of the prepared N-(2,4-dichlorophenoxyacetyl)-L-cysteine 74 could not be determined accurately by the direct analysis of the thiol. Instead the thiol was covalently modified by exposing a sample to an excess of N-(2-aminoethyl)maleimide hydrochloride 64 in DMSO-d6. NMR analysis of this mixture and integration of 1H-NMR proton signals in the aromatic region revealed that >95% of the 2,4-D derivatives in the sample were the thio-Michael adduct 76, and therefore prepared N-(2,4-dichlorophenoxyacetyl)-L-cysteine 74 must be >95% of the 2,4-D-derivatives in the prepared batch (see FIG. 8 or see below).

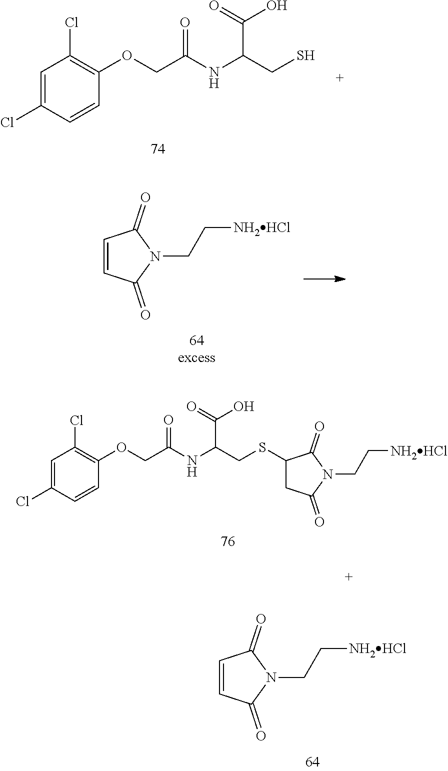

Furthermore, very little change or degradation was found in a sample obtained from the prepared N-(2,4-dichlorophenoxyacetyl)-L-cysteine 74 that was stored in a refrigerator at 8° C. for 2 weeks. The NMR analysis was again performed on a mixture obtained by exposing sample thiol to an excess of N-(2-aminoethyl)maleimide hydrochloride 64 in DMSO-d6 (see FIG. 9 or see below).

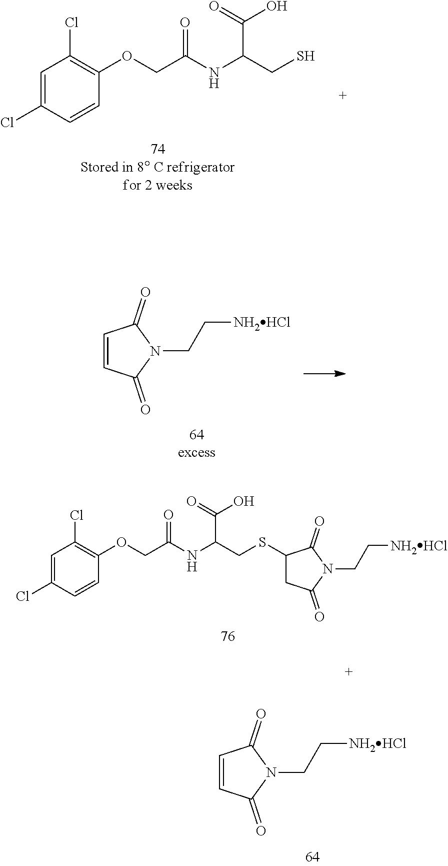

The proton peak assignments in these 1H NMR's was supported by COSY 2D NMR analysis of the thiol-Michael adduct 76 mixture (see FIGS. 10 and 11). For further discussion of NMR analyses of maleimide thiol thiol-Michael adducts see “Hydrogen-Deuterium Addition and Exchange in N-Ethylmaleimide Reaction with Glutathione Detected by NMR Spectroscopy” G. A. N. Gowda, V. Pascua, F. C. Neto, and D. Raftery, ACS Omega 2022, 7, 26928-26935. The ratio of dry to wet weight of N-(2,4-dichlorophenoxyacetyl)-L-cysteine 74 in this batch was determined to be 1 mg dry to 38.2 mg wet N-(2,4-dichlorophenoxyacetyl)-L-cysteine 74. The material was used wet to minimize handling and avoid disulfide formation. The amount of dry N-(2,4-dichlorophenoxyacetyl)-L-cysteine 74 used in subsequent experiments was calculated based on the wet N-(2,4-dichlorophenoxyacetyl)-L-cysteine 74 weight used.

### Example 5: N-(2,4-Dichlorophenoxyacetyl)-L-Cysteine 74 Conjugation to Alg-N-AEMI 66 (See Below)

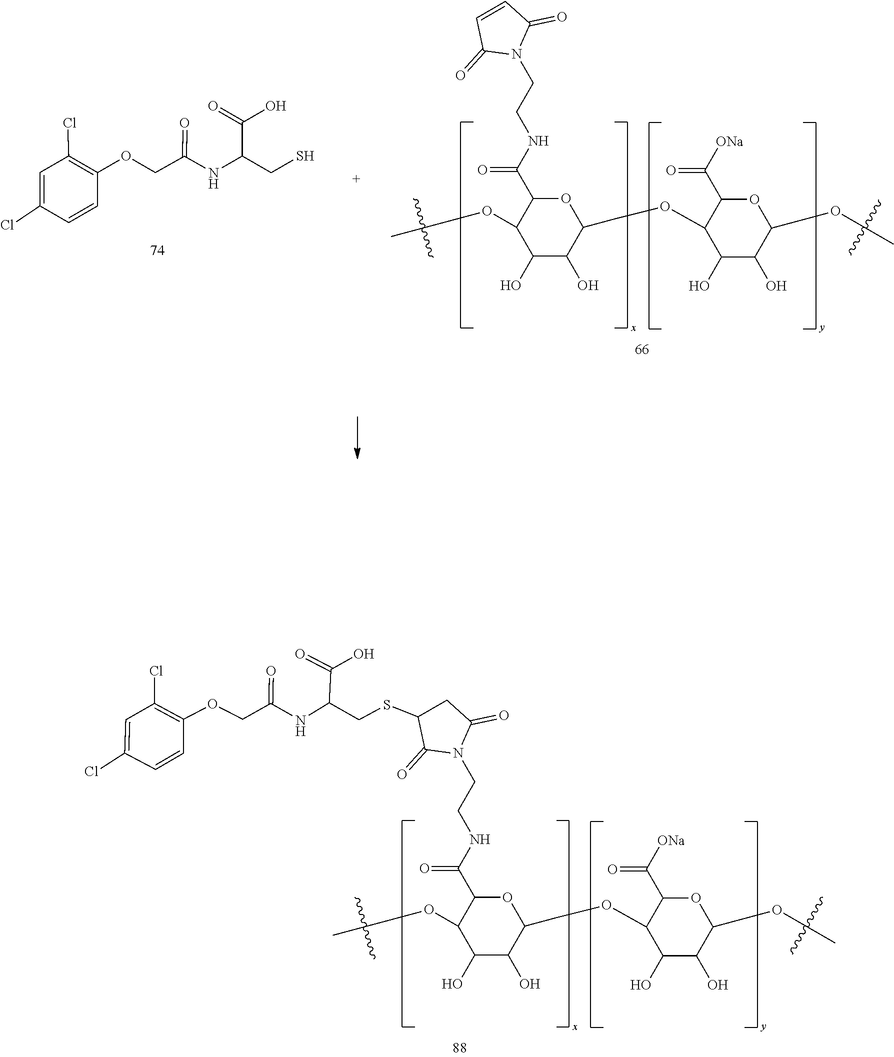

150 mg of Alg-N-AEMI 66 was dissolved in 10 mL of water. 1.0713 g of wet N-(2,4-dichlorophenoxyacetyl)-L-cysteine 74 (36.21 mg of dry weight equivalent) was added to this mixture. The mixture was stirred at room temperature overnight. The reaction mixture was then placed in SnakeSkin Dialysis tubing 3.5K MWCO knotting the two ends. Dialyzed against 1000 mL 1×PBS+5 mL 10% aqueous NaOH (pH ˜12) for 24 hours. Then dialyzed against 1000 mL 150 mM aq. NaCl for 24 hours. Then dialyzed against 1000 mL of deionized water for 24 hours. Then again dialyzed against 1000 mL of deionized water for 24 hours. Lyophilized to obtain 100.6 mg of a white foam. 12 mg of the material thus obtained, Alg-N-succinimidyl-thioether-2,4-D conjugate 88, was dissolved in D₂O and analyzed by NMR at 50° C. The vinyl maleimide protons of Alg-N-AEMI 66 (the starting material) seen at ˜7.2 ppm in the 1H NMR spectrum of Alg-N-AEMI 66 (FIG. 14) are not observed in the Alg-N-succinimidyl-thioether-2,4-D conjugate 88 1H NMR spectrum indicating complete consumption of maleimide during Cys-2,4-D 74 conjugation. Furthermore, the appearance of characteristic aromatic 2,4-D proton signals in the aromatic region (7-8 ppm) in the Alg-N-succinimidyl-thioether-2,4-D conjugate 88 1H NMR spectrum reflects the success of the conjugation.

### Example 6: Alg-N-AEMI-Ca-Crosslinked-Pellets Prepared by Alginate Crosslinking with Calcium Chloride

1 g of alginate Alg-N-AEMI 66 was placed in 75 mL of deionized water (1.33 w/v %) and stirred overnight to dissolve. A 0.2 w/v % solution of calcium chloride was prepared by dissolving 428 mg of calcium chloride in 214 mL of deionized water. The alginate solution was placed in a separatory funnel and added dropwise to the stirred calcium chloride solution. Addition required ˜2 hrs. Stirred for an additional 10 minutes upon complete addition. The mixture was filter through filter paper and washed with 2×400 mL of deionized water to obtain Alg-N-AEMI-Ca-Crosslinked-Pellets. The pellets were stored in a refrigerator at 8° C. This preparation was adapted from a published procedure, see B. Tomadoni, M. F. Salcedo, A. Y. Mansilla, C. A. Casalongué, V. A. Alvarez, European Polymer Journal 2020, 137, 109953.

### Example 7: Ellman's Assay (See Below)

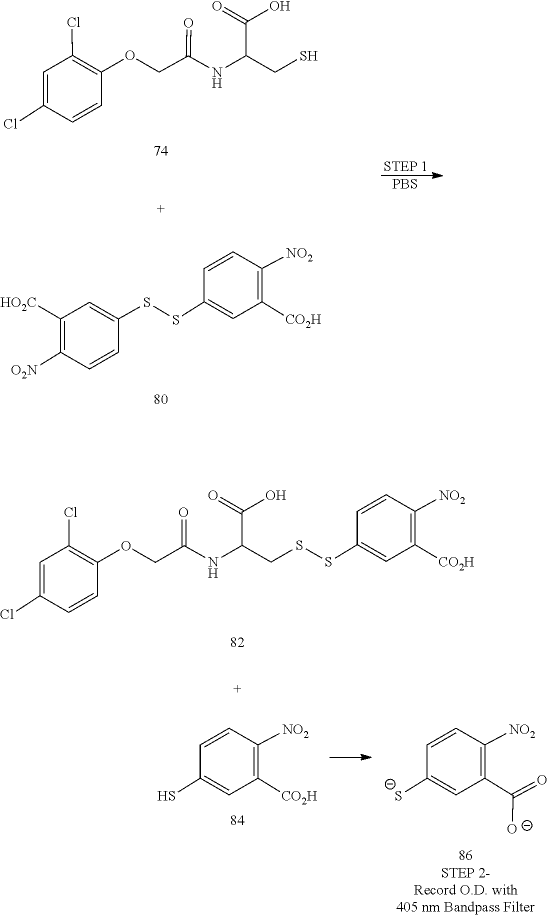 [SMILES: O=C(COc1ccc(Cl)cc1Cl)NC(CS)C(=O)O ; "PBS" ; O=C(O)c1cc(SSc2ccc([N+](=O)[O-])c(C(=O)O)c2)ccc1[N+](=O)[O-] ; O=C(COc1ccc(Cl)cc1Cl)NC(CSSc1ccc([N+](=O)[O-])c(C(=O)O)c1)C(=O)O ; O=C(O)c1cc(S)ccc1[N+](=O)[O-] ; O=C([O-])c1cc([S-])ccc1[N+](=O)[O-]]

A stock solution of Ellman's Reagent 80 (5,5′-dithiobis-(2-nitrobenzoic acid), DTNB) was prepared with a concentration of 1.42 mg per mL of PBS. A fresh control solution of cysteine was prepared with a concentration of 0.866 mg per mL of PBS. A fresh solution of N-(2,4-dichlorophenoxyacetyl)-L-cysteine 74 was prepared with a concentration of approximately 1.25 mg (dry weight equivalent) per mL of PBS and 10 μL of 10% aq. NaOH per 1 mL of PBS (pH found to be ˜8). Samples were prepared by combining 100 μL of the DTNB stock solution with 100 μL of the thiol solution to be assayed. The resulting mixture was allowed to stand at room temperature for 5 minutes before measuring the O.D. on an absorbance microplate reader using a 405 nm Bandpass Filter. Readings were also made of 100 μL of the DTNB stock solution combined with 100 μL of PBS and subtracted from sample O.D. readings. Thiol stability could be monitored using the Ellman's Assay by, for example, assaying a N-(2,4-dichlorophenoxyacetyl)-L-cysteine 74 solution over time. % Thiol was determined by calculating (Δ O.D./Δ O.D. initial) where Δ O.D. is the sample O.D.—O.D. of (100 μL DTNB stock solution combined with 100 μL of PBS) and Δ O.D. initial is the Δ O.D. determined from the first analysis of the N-(2,4-dichlorophenoxyacetyl)-L-cysteine 74 solution. Due to the low concentration of thiol in a sample assayed at 16 days, % Thiol at 16 days (384 hours) was determined by: 1) finding the equivalence point between the cysteine solution and the DTNB stock solution, then 2) screening combinations of the cysteine solution and DTNB stock solution to identify the amount of cysteine solution that produced approximately the same O.D. as the 16 day sample when combined with the DTNB stock solution. The amount of thiol in the 16 day sample was assumed to be equal to the amount of thiol calculated to be in the corresponding amount of cysteine stock solution that produced a matching O.D. when combined with the DTNB stock solution. The % thiol in the 16 day sample was calculated by dividing the determined amount of thiol by the amount of N-(2,4-dichlorophenoxyacetyl)-L-cysteine 74 in the stock solution calculated based on the mass estimated to have been used to prepare the stock solution, and then multiplying by 100.

### Example 8: Reaction with 4-Nitrobenzenethiol 92 to Examine Retained Thiol Reactivity of Pellets in Soil (See Below)

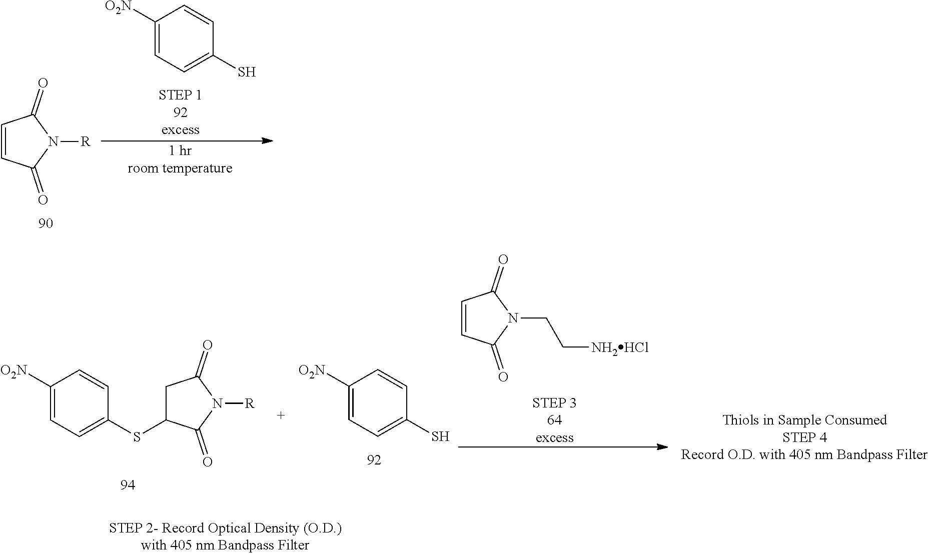

Alg-N-AEMI-Ca-Crosslinked-Pellets versus Alg-Ca-Crosslinked-Pellets were tested. Samples were prepared by placing 10 pellets per sample (average total mass ˜700 mg) were placed in mesh bags (tea filter bags 2.36×2.75 inch). The mesh bags containing the pellets were folded up and placed in 20 mL vials. ˜2.5 g of soil was placed around and on top of the mesh bags in the vials. The vials were topped off with water (Primo water—originates from municipal sources. It then goes through a nine-step purification process that involves filtration, UV sterilization and mineral addition). Sample vials were capped and either stored at room temperature or placed in an incubator/shaker at 60° C. Samples were analyzed at the times noted.

At the appropriate time, a sample was opened, the soil removed, and the mesh bag recovered. The pellets were removed from the bag, placed in a 20 mL vial and their mass was determined. The pellets were then washed with 4×20 mL of Primo water. And excess water was decanted off the washed pellets.

A fresh solution of 4-nitrobenzenethiol 92 was prepared with a concentration of 16.74 mg per 15 mL of PBS. A solution of N-(2-aminoethyl)maleimide hydrochloride 64 was prepared with a concentration of 7.9 mg per mL of PBS.

Combined 1 μL of the 4-nitrobenzenethiol 92 solution per milligram of pellets, and then placed the samples on an orbital shaker for 1 hr at room temperature. A control thiol sample was prepared by placing 1 mL of the 4-nitrobenzenethiol 92 solution in a 20 mL vial that was also placed on the orbital shaker for 1 hr at room temperature. The samples and control were analyzed by plating two 200 μL aliquots per sample or control and measuring the O.D. of each aliquot on an absorbance microplate reader using a 405 nm Bandpass Filter. 50 μL of the N-(2-aminoethyl)maleimide hydrochloride 64 solution was then added to one of the aliquots per sample or control and after standing at room temperature for 5 minutes the O.D. was again recorded. Results are presented in FIG. 18.

$$Percent \% = ( Sample O . D . - Base ) / ( Control Thiol O . D . - Base ) \times 100$$

$$Base = O . D . reading after addition of excess Maleimide$$

### Example 9: Amounts of 2,4-D 68 Retained by Alg-N-AEMI-Ca-Crosslinked-Pellets Versus Alg-Ca-Crosslinked-Pellets when they are Treated with Cys-2,4-D 74 as a PBS Solution In Vitro for ˜24 Hours (See Below)

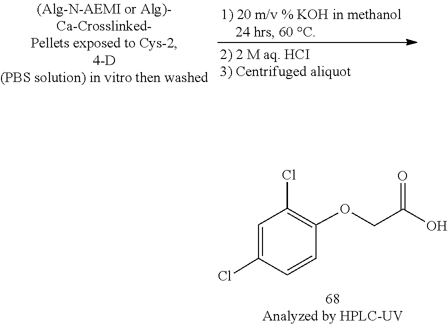 [SMILES: O=C(O)COc1ccc(Cl)cc1Cl]

Alg-N-AEMI-Ca-Crosslinked-Pellets versus Alg-Ca-Crosslinked-Pellets were tested. Samples were prepared by placing ˜1.5 g of the respective pellets per sample were placed in a 20 mL vial. A N-(2,4-dichlorophenoxyacetyl)-L-cysteine 74 stock solution was prepared with a concentration of 2.317 mg (dry weight equivalent) per 1 mL of PBS with 10 μL of 10% aqueous NaOH per mL of PBS (NaOH added to adjust the pH such that Cys-2,4-D 74 goes into solution, pH adjusted to ˜8). Each sample of pellets was combined with 3 mL of the Cys-2,4-D 74 stock solution, capped, and placed on an orbital shaker for 2 hours at room temperature. The samples were then allowed to stand on the benchtop for ˜22 hrs at room temperature.

The next day, the pellets in each sample were washed with 2×20 mL 0.1% aq. NaOH, and 2×40 mL of water, and then placed in a new 20 mL vial. Each sample of pellets was treated with 1 mL of 20% m/v potassium hydroxide in methanol and placed in an incubator/shaker for 24 hours at 60° C. Each sample was then combined with 2 mL of 2 M aq. HCl, a 1 mL aliquot was centrifuged, and then from that aliquot a 200 μL HPLC sample was prepared. The samples were analyzed by HPLC-UV run on an HP1050 HPLC system equipped with a Variable Wavelength Detector set to 228 nm. The HPLC column used was a Kromasil 100-10PHENYL 250×4.6 mm E22530 (Temperature 24° C.). The solvent system was isocratic and composed of H₂O (with 0.1% trifluoroacetic acid) and methanol (solvent system was H₂O w/0.1% TFA:MeOH 40:60), flowing at 2 mL per minute. 10 μL of sample was injected per sample using the HP1050 Autosampler. The HPLC results are presented in FIG. 20.

### Example 10: Amounts of 2,4-D 68 Retained by Alg-N-AEMI-Ca-Crosslinked-Pellets Versus Alg-Ca-Crosslinked-Pellets when they are Treated with Cys-2,4-D as a PBS Solution in Soil for ˜24 Hours (See Below)

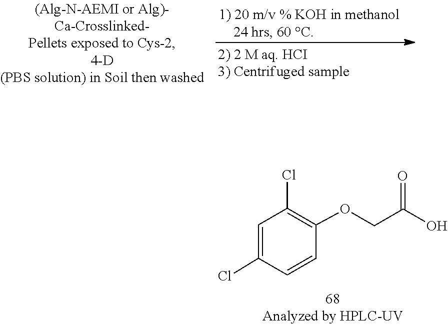 [SMILES: O=C(O)COc1ccc(Cl)cc1Cl]

Alg-N-AEMI-Ca-Crosslinked-Pellets versus Alg-Ca-Crosslinked-Pellets were tested. Samples were prepared by placing ˜1.5 g of pellets per sample were placed in mesh bags (tea filter bags 2.36×2.75 inch). The mesh bags containing the pellets were folded up and placed in 20 mL vials. ˜2 g of soil was placed on top of the mesh bags in the vials. A N-(2,4-dichlorophenoxyacetyl)-L-cysteine 74 stock solution was prepared with a concentration of 2.317 mg (dry weight equivalent) per 1 mL of PBS with 10 μL of 10% aqueous NaOH per mL of PBS (NaOH added to adjust the pH such that Cys-2,4-D 74 goes into solution, pH adjusted to ˜8). Each sample of pellets was combined with 3 mL of the Cys-2,4-D 74 stock solution, capped, and placed on an orbital shaker for 2 hours at room temperature. The samples were then allowed to stand on the benchtop for ˜22 hrs at room temperature.

The next day, the pellets in each sample were washed with 2×40 mL 0.05% aq. NaOH, and 2×40 mL of water, and then placed in a new 20 mL vial. Each sample of pellets was treated with 1 mL of 20% m/v potassium hydroxide in methanol and placed in an incubator/shaker for 24 hours at 60° C. Each sample was then combined with 2 mL of 2 M aq. HCl, a 1 mL aliquot was centrifuged, and then from that aliquot a 200 μL HPLC sample was prepared. The samples were analyzed by HPLC-UV run on an HP1050 HPLC system equipped with a Variable Wavelength Detector set to 228 nm. The HPLC column used was a Kromasil 100-10PHENYL 250×4.6 mm E22530 (Temperature 24° C.). The solvent system was isocratic and composed of H₂O (with 0.1% trifluoroacetic acid) and methanol (solvent system was H₂O w/0.1% TFA:MeOH 40:60), flowing at 2 mL per minute. 10 μL of sample was injected per sample using the HP1050 Autosampler. The HPLC results are presented in FIG. 23.

### Example 11: Soil Extraction and HPLC Analysis to Determine 2,4-D Content

Soil samples were either treated with 2,4-D, Cys-2,4-D-Conjugated-Alg-N-AEMI-Ca-Crosslinked-Pellets, or left untreated. One soil sample was treated with 0.051 mg of 2,4-D 68 per gram of soil (˜40 grams of soil). Cys-2,4-D-Conjugated-Alg-N-AEMI-Ca-Crosslinked-Pellets were prepared by combining 4.8 g of Alg-N-AEMI-Ca-Crosslinked-Pellets in a 20 mL vial with 9 mL of a N-(2,4-dichlorophenoxyacetyl)-L-cysteine solution with a concentration of 2.317 mg (dry weight equivalent) per 1 mL of PBS with 10 μL of 10% aqueous NaOH per mL of PBS (NaOH added to adjust the pH such that Cys-2,4-D goes into solution, pH adjusted to ˜8). The vial was capped and placed on an orbital shaker for 2 hours at room temperature. The sample was then allowed to stand on the benchtop for ˜22 hrs at room temperature. The next day, the pellets were washed with 2×40 mL 0.05% aq. NaOH, and 2×40 mL of water, and then placed in a new 20 mL vial. Cys-2,4-D-Conjugated-Alg-N-AEMI-Ca-Crosslinked-Pellets were applied to another soil sample at rate of 57 mg per gram of soil (˜56 grams of soil). For both soil samples, the soil was placed in separate seedling trays under grow lights and vent with the lights on for 15 hours a day under a humidity dome, and was misted with 1.5 mL of water per day. The seedling trays were heated on a seedling heat mat. The last condition tested was untreated soil where nothing was applied to the soil (˜36 grams of soil). The soil samples were extracted with acetonitrile (50 mL per ˜40 g of soil), and then filtered through filter paper to obtain an organic layer. The organic layer was concentrated in vacuo, and 1 mL of the residue combined with 1 mL of 20% m/v KOH in methanol and then acidified with 2 mL of 2 M aq. HCl. A 1 mL aliquot from each sample was centrifuged, and then from that aliquot a 200 μL HPLC sample was prepared. The samples were analyzed by HPLC-UV run on an HP1050 HPLC system equipped with a Variable Wavelength Detector set to 228 nm. The HPLC column used was a Kromasil 100-10PHENYL 250×4.6 mm E22530 (Temperature 24° C.). The solvent system was isocratic and composed of H₂O (with 0.1% trifluoroacetic acid) and methanol (solvent system was H₂O w/0.1% TFA:MeOH 40:60), flowing at 2 mL per minute. 10 μL of sample was injected per sample using the HP1050 Autosampler. 2,4-D was detected in the 2,4-D treated soil sample and the Cys-2,4-D-Conjugated-Alg-N-AEMI-Ca-Crosslinked-Pellets treated soil sample as seen in the respective 2,4-D peak areas per gram of soil (FIG. 26). A 2,4-D peak in the HPLC trace for the untreated soil sample was not observed in the HPLC analysis (for an example trace with a 2,4-D peak see FIG. 21). Integration of the respective region in the HPLC trace associated with the 2,4-D peak yielded a negative peak area.

### Example 12: Plant Survival Study

Sinapis arvensis (wild mustard) plants were grown from seeds obtained from GIFTfromNATURE (Burgas, Bulgaria) in seedling trays with humidity domes and grow lights with vents (obtained from Yskea Store—Amazon.com, see FIG. 28) usually with one plant per seedling tray cell. The seedling trays were heated on seeding heat mats. The soil used was Purple Cow Organics seed starter mix. Grow lights were operated on a timer for 15 consecutive hours a day starting at 5:30 a.m. Seeds were planted on 7/31. Seedling were then treated 12 days after planting on 8/12 with conditions presented below. Nine groups were studied, where seedling trays were dedicated to only one of these groups per tray. Group 1 (2 plants) was left untreated, without pellets or pesticides. Group 2 (6 plants) was treated with Alg-N-AEMI-Ca-Crosslinked-Pellets applied at a rate of 7 pellets per plant. Group 3 (7 plants) was treated with 0.096 mg N-(2,4-dichlorophenoxyacetyl)-L-cysteine (Cys-2,4-D 74) per plant (100 μL of solution with 0.96 mg Cys-2,4-D per mL PBS and 10 μL of 10% aq. NaOH per mL of PBS, 0.40 lb acid equivalent per acre). Group 4 (12 plants) was treated with Cys-2,4-D-Conjugated-Alg-N-AEMI-Ca-Crosslinked-Pellets that were linked in the soil. In soil linking was achieved as follows: Alg-N-AEMI-Ca-Crosslinked-Pellets were applied at a rate of 7 pellets per plant. 0.096 mg N-(2,4-dichlorophenoxyacetyl)-L-cysteine (Cys-2,4-D 74) per plant (100 μL of solution with 0.96 mg Cys-2,4-D per mL PBS and 10 μL of 10% aq. NaOH per mL of PBS, 0.40 lb acid equivalent per acre) was then applied to the pellets and plants. Group 5 (7 plants) was treated with Cys-2,4-D-Conjugated-Alg-N-AEMI-Ca-Crosslinked-Pellets that were linked in the soil. In soil linking was achieved as follows: Alg-N-AEMI-Ca-Crosslinked-Pellets were applied at a rate of 7 pellets per plant. 0.0192 mg N-(2,4-dichlorophenoxyacetyl)-L-cysteine (Cys-2,4-D 74) per plant (100 μL of solution with 0.192 mg Cys-2,4-D per mL PBS and 2 μL of 10% aq. NaOH per mL of PBS, 0.08 lb acid equivalent per acre) was then applied to the pellets and plants. Group 6 (12 plants) was treated with Cys-2,4-D-Conjugated-Alg-N-AEMI-Ca-Crosslinked-Pellets that were linked in the soil. Alg-N-AEMI-Ca-Crosslinked-Pellets were applied at a rate of ˜7 pellets per plant. 0.0096 mg N-(2,4-dichlorophenoxyacetyl)-L-cysteine (Cys-2,4-D 74) per plant (100 μL of solution with 0.096 mg Cys-2,4-D per mL PBS and 1 μL of 10% aq. NaOH per mL of PBS, 0.04 lb acid equivalent per acre) was then applied to the pellets and plants. Group 7 (5 plants) was treated with 0.25 mg 2,4-D per plant (100 μL of solution with 2.5 mg 2,4-D per mL PBS and 10 μL of 10% aq. NaOH per mL of PBS, 1.5 lb 2,4-D per acre). Group 8 (14 plants) was treated with 0.025 mg 2,4-D per plant (100 μL of solution with 0.25 mg 2,4-D per mL PBS and 1 μL of 10% aq. NaOH per mL of PBS, 0.15 lb 2,4-D per acre). And Group 9 (7 plants) was treated with 0.05 mg 2,4-D per plant (100 μL of solution with 0.5 mg 2,4-D per mL PBS and 2 μL of 10% aq. NaOH per mL of PBS, 0.30 lb 2,4-D per acre). All plants were watered on the dates where plant survival was assessed (every 3 days) with 0.5 mL of Primo water per plant (Primo water—originates from municipal sources. It then goes through a nine-step purification process that involves filtration, UV sterilization and mineral addition). Groups 1, 2, 5, 6, and 9 maintained 100% survival throughout the study. Both Group 7, the plants treated 0.25 mg 2,4-D per plant (100 μL of solution with 2.5 mg 2,4-D per mL PBS and 10 μL of 10% aq. NaOH per mL of PBS, 1.5 lb 2,4-D per acre) and Group 4, the plants treated with Cys-2,4-D-Conjugated-Alg-N-AEMI-Ca-Crosslinked-Pellets linked in the soil using 0.096 mg N-(2,4-dichlorophenoxyacetyl)-L-cysteine (Cys-2,4-D 74) per plant (100 μL of solution with 0.96 mg Cys-2,4-D per mL PBS and 10 μL of 10% aq. NaOH per mL of PBS, 0.40 lb acid equivalent per acre) were comparable and had the lowest two % survival by the end of this study. See FIG. 30.

### RELEVANT ART MAY INCLUDE

### U.S. Patents

| | | |
|---|---|---|
| U.S. Pat. Publ. 2016/0120987 | May 2016 | J. M. M. Oneto et al. |
| U.S. Pat. No. 4,267,280 | May 12, 1981 | C. L. McCormick |
| U.S. Pat. No. 9,861,096 B2 | Jan. 9, 2018 | M. W. Frey et al |
| US Pat. Publ. 2019 / 0116786 A1 | Apr. 25, 2019 | M. W. Burnet et al. |

### Foreign Patent Documents

| | | |
|---|---|---|
| WO 2015/154082 A1 | Oct. 8, 2015 | Y. Brudno et al. |
| WO 02/21913 A2 | Mar. 21, 2002 | J. Asrar et al. |
| WO 2015/059580 A1 | Apr. 30, 2015 | M. W. Burnet et al. |

### Other References

Pesticides use 2022—FAOSTAT Analytical Brief 89
“Bioorthogonal Chemistry: Fishing for Selectivity in a Sea of Functionality” E. M. Sletten C. R. Bertozzi, Angew Chem Int Ed Engl. 2009, 48, 6974-6998.
“Click Chemistry in Complex Mixtures: Bioorthogonal Bioconjugation” C. S. McKay and M. G. Finn, Chem Biol. 2014, 21, 1075-1101.
“Bioconjugate Techniques” G. T. Hermanson, 2013, 3^{rd} edition, Academic Press.
“Harnessing biocompatible chemistry for developing improved and novel microbial cell factories” J.-M. Liu, C. Solem, and P. R. Jensen, Microbial Biotechnology 2020, 13, 54-66.
“The Thiol-Michael Addition Click Reaction: A Powerful and Widely Used Tool in Materials Chemistry” D. P. Nair, M. Podgórski, S. Chatani, T. Gong, W. Xi, C. R. Fenoli, and C. N. Bowman, Chem. Mater. 2014, 26, 724-744.
“Hydrogen-Deuterium Addition and Exchange in N-Ethylmaleimide Reaction with Glutathione Detected by NMR Spectroscopy” G. A. N. Gowda, V. Pascua, F. C. Neto, and D. Raftery, ACS Omega 2022, 7, 26928-26935.
“Tunable degradation of maleimide-thiol adducts in reducing environments” A. D. Baldwin and K. L. Kiick, Bioconjug Chem. 2011, 22, 1946-1953.
“Long-Term Stabilization of Maleimide-Thiol Conjugates” S. D. Fontaine, R. Reid, L. Robinson, G. W. Ashley, and D. V. Santi, Bioconjugate Chem. 2015, 26, 145-152.
“Direct and Indirect Biomimetic Peptide Modification of Alginate: Efficiency, Side Reactions, and Cell Response” A. Golunova, N. Velychkivska, Z. Mikšovská, V. Chochola, J. Jaroš, A. Hampl, O. Pop-Georgievski and V. Proks, Int. J. Mol. Sci. 2021, 22, 5731.
“Thiolated polymers: Stability of thiol moieties under different storage conditions” A. Bernkop-Schnurch, M. D. Hornof, C. E. Kast and N. Langoth, Sci. Pharm. 2002, 70, 331-339.
“Development of a modular, biocompatible thiolated gelatin microparticle platform for drug delivery and tissue engineering applications” H. A. Pearce, Y. S. Kim, E. Watson, K. Bahrami, M. M. Smoak, E. Y. Jiang, M. Elder, T. Shannon and A. G. Mikos, Regenerative Biomaterials, 2021, 1-12.
“Design and Preparation Of A Novel Hydrogel Based An Maleimide-Thiol Conjugation” S. Jiang and M. Mohanty, bioRxiv 2023.03.19.533362.
“Retro-Diels-Alder Reaction: Possible Involvement in the Metabolic Activation of 7-Oxabicyclo[2.2.1]hepta-2(3),5(6)-diene-2,3-dicarboxylates and a Phosphonate Analog” M. Mahajna, G. B. Quistad, and J. E. Casida, Chem. Res. Toxicol. 1996, 9, 241-246.
“SYNTHETIC PLANT-GROWTH REGULATORS. III. 2,4-DICHLOROPHENOXYACETYL DERIVATIVES OF AMINO ACIDS” J. W. Wood and T. D. Fontaine, J. Org. Chem. 1952, 17, 891-896.
“Thermosensitive hydrogels synthesized by fast Diels-Alder reaction in water” H.-L. Wei, Z. Yang, L.-M. Zheng, Y.-M. Shen, Polymer, 2009, 50, 2836-2840.
“A Self-Healing Cellulose Nanocrystal-Poly(ethylene glycol) Nanocomposite Hydrogel via Diels-Alder Click Reaction” C. Shao, M. Wang, H. Chang, F. Xu, and J. Yang, ACS Sustainable Chem. Eng. 2017, 5, 6167-6174.
“Novel utilizations of conventional agrochemicals by controlled release formulations” A. Akelah, Mat. Sci. Eng. C 1996, 4, 83-98.
“Polymer in Agriculture: a Review” F. Puoci, F. lemma, U. G. Spizzirri, G. Cirillo, M. Curcio and N. Picci, J. Agri. & Biol. Sci. 2008, 3, 299-314.
“Controlled release agrochemicals formulations: A review” S. Dubey, V. Jhelum, and P. K. Patanjali, J. Sci. Ind. Res. 2011, 70, 105-112.
“Polymers as controlled delivery systems in agriculture: The case of atrazine and other pesticides” A. Zanino, F. Pizzetti, M. Masi, F. Rossi, European Polymer Journal 2024, 203, 112665.
“Engineering Biomaterial-Drug Conjugates for Local and Sustained Chemotherapeutic Delivery” J. M. Coburn and D. L. Kaplan, Bioconjug Chem. 2015, 26, 1212-1223.
Translating controlled release systems from biomedicine to agriculture, P. Lee, X. Lin, F. Khan, A. E. Bennett and J. O. Winter, Front. Biomater. Sci. 2022, 1:1011877.
“Recent Trends in Advanced Polymer Materials in Agriculture Related Applications” A. Sikder, A. K. Pearce, S. J. Parkinson, R. Napier, and R. K. O'Reilly, ACS Appl. Polym. Mater. 2021, 3, 1203-1217.
“Herbicide Formulation” R. L. Zimdahl, Fundamentals of Weed Science 2018, 501-509.
“Macroporous alginate-based hydrogels to control soil substrate moisture: Effect on lettuce plants under drought stress” B. Tomadoni, M. F. Salcedo, A. Y. Mansilla, C. A. Casalongué, V. A. Alvarez, European Polymer Journal 2020, 137, 109953.
“Superabsorbent polymers used for agricultural water retention” L. Chang, L. Xu, Y. Liu, and D. Qiu, Polymer Testing 2021, 94, 107021.
“Alginate-based composites as novel soil conditioners for sustainable applications in agriculture: A critical review” N. Wang, B. Wang, Y. Wan, B. Gao, V. D. Rajput, Journal of Environmental Management 2023, 348, 119133.
“Controlled Release Formulations of Agrochemicals from Calcium Alginate” El-Refaie Kenawy and M. A. Sakran, Ind. Eng. Chem. Res. 1996, 35, 3726-3729.
“Paraquat-loaded alginate/chitosan nanoparticles: Preparation, characterization and soil sorption studies” M. S. Silva, D. S. Cocenza, R. Grillo, N. F. Silva de Melo, P. S. Tonello, L. Camargo de Oliveira, D. L. Cassimiro, A. H. Rosa, L. F. Fraceto, J. Hazard. Mater. 2011, 190, 366-374.
“Review and Perspectives of the Use of Alginate as a Polymer Matrix for Microorganisms Applied in Agro-Industry” B. Martínez-Cano, C. J. Mendoza-Meneses, J. F. García-Trejo, G. Macías-Bobadilla, H. Aguirre-Becerra, G. M. Soto-Zarazúa, and A. A. Feregrino-Pérez, Molecules 2022, 27, 4248.
“Encapsulation of Plant Biocontrol Bacteria with Alginate as a Main Polymer Material” R. S. Riseh, Y. A. Skorik, V. K. Thakur, M. M. Pour, E. Tamanadar and S. S. Noghabi, Int. J. Mol. Sci. 2021, 22, 11165.
“Encapsulated Bacillus thuringiensis powders by internal gelation of alginate microspheres for stability” Y. Junxina, C. Defub and Y. Jia, Advanced Materials Research 2011, 183-185, 272-277.
“Structure of Dried Cellular Alginate Matrix Containing Fillers Provides Extra Protection for Microorganisms against UVC Radiation” C. Zohar-Perez, L. Chernin, I. Chetc and A. Nussinovitch, Radiation Research 2003, 160, 198-204.
“Diffusion of Microorganisms in Calcium Alginate Beads” C. Quirós, M. Rendueles, L. A. García and M. Díaz, Biotechnology Techniques 1995, 9, 809-814.
“Encapsulation of plant growth-promoting bacteria in alginate beads enriched with humic acid” C.-C. Young, P. D. Rekha, W.-A. Lai, A. B. Arun, Biotechnology and Bioengineering 2006, 95, 76-83.
“Alginate beads as a storage, delivery and containment system for genetically modified PCB degrader and PCB biosensor derivatives of Pseudomonas fluorescens F113” B.
Power, X. Liu, K. J. Germaine, D. Ryan, D. Brazil, D. N. Dowling, Journal of Applied Microbiology 2011, 110, 1351-1358.
“Continuous degradation of maltose by enzyme entrapment technology using calcium alginate beads as a matrix” M. A. Nawaz, H. Ur Rehman, Z. Bibi, A. Aman, S. A. Ul Qader, Biochemistry and Biophysics Reports 2015, 4, 250-256.
“Alginate: properties and biomedical applications” K. Y. Lee and D. J. Mooney, Prog. Polym. Sci. 2012, 37, 106-126.

All publications, patents, and patent documents cited herein are incorporated by reference as though individually incorporated by reference, although no limitations inconsistent with this disclosure are to be understood therefrom. The invention has been described with reference to various specific and preferred embodiments and techniques. However, many variations and modifications may be made while remaining within the spirit and scope of the invention.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

What is claimed is:

1. A composition comprising:
a biocompatible solid support comprising a hydrogel, polymer, sugar based biomaterial, protein or poly(amino-acid), each of which is modified; and at least one binding agent covalently linked to the biocompatible solid support via a linker, wherein at least one binding agent is one of a pair of binding agents capable of a click reaction, wherein the click reaction is a reaction between a maleimide and a thiol.

2. The composition of claim 1, wherein the biocompatible solid support comprises a polysaccharide hydrogel, alginate, cellulose, hyaluronic acid, chitosan, chitin, chondroitin sulfate, or heparin, each of which is modified.

3. The composition of claim 1, wherein the biocompatible solid support is modified by esterification of carboxylic acids, conversion of alcohols to ethers, esters or carbamates, conversion of acids to amides, or conversions of amines to amides or ureas.

4. The composition of claim 1, wherein the biocompatible solid support comprises modified alginate.

5. The composition of claim 1, wherein at least one binding agent comprises maleimide.

6. The composition of claim 1, wherein the reaction is in a plant growth medium.

7. A composition comprising:
a biocompatible solid support comprising a hydrogel, polymer, sugar based biomaterial, protein or poly(amino-acid), each of which is modified; and at least one binding agent covalently linked to the biocompatible solid support via a linker, wherein at least one binding agent is one of a pair of binding agents capable of a click reaction, wherein the click reaction is a reaction between a maleimide and a furan.

8. A method for delivering an effective amount of a pesticide to an application environment in a plant growth medium, comprising the steps of:
(a) contacting a biocompatible solid support with a first binding agent, wherein the biocompatible solid support is thereby linked to the first binding agent, to obtain a receptive biocompatible solid support;
(b) applying to a plant growth medium the receptive biocompatible solid support;
(c) contacting the receptive biocompatible solid support with the conjugating agent comprising the pesticide linked to the second binding agent wherein the link comprises a cleavable linkage to the pesticide, such that the first and second binding agents link to one another upon contact, thereby linking the pesticide to the biocompatible solid support, to obtain the controlled release system;
wherein the cleavable linkage to the pesticide in the controlled release system cleaves, and therefore the controlled release system controllably releases an effective amount of pesticide to the application environment.

9. The method of claim 8 wherein the cleavable linkage to the pesticide in the controlled release system cleaves under environmental conditions.
